(19) United States
(12) Patent Application Publication
(10) Pub. No.: US 2012/0187836 A1
(43) Pub. Date: Jul. 26, 2012

(54) LAMP AND LIGHTING APPARATUS

(76) Inventors: Naotaka Hashimoto, Osaka (JP); Shinya Kawagoe, Osaka (JP); Toshikazu Endo, Osaka (JP); Hideaki Kiryu, Osaka (JP); Kazuhiko Itoh, Osaka (JP); Masahiro Miki, Osaka (JP)

(21) Appl. No.: 13/265,828

(22) PCT Filed: May 31, 2011
(86) PCT No.: PCT/JP2011/003046

§ 371 Date: Oct. 21, 2011

(30) Foreign Application Priority Data
Jun. 2, 2010 (JP) 2010-126794
Jun. 28, 2010 (JP) 2010-145850
Jun. 30, 2010 (JP) 2010-149122
Jun. 30, 2010 (JP) 2010-149123
Jan. 5, 2011 (JP) 2011-000323

(51) Int. Cl. F21V 23/00; F21V 17/12; F21V 15/01; F21V 5/04; F21V 21/02

(52) U.S. Cl. 315/51

(57) ABSTRACT

Lamp realizing high brightness without increase in size, including: case 3 that is in conical shape, wherein LEDs 37 are installed on inner surface of bottom 5 of case 3; lens 13 that is smaller than case 3 in size and positioned in case 3 such that light emission face 63 of lens 13 is on opening side of case 3; cover 15 that is installed to cover opening of case 3 so that light emitted from face 63 is extracted to outside of lamp; base member 17 that is hollow inside and attached to outer surface of bottom 5 of case 3 to project toward outside; and lighting circuit 23 that receives electricity via base member 17, and causes LEDs 37 to emit light. Electronic parts 49, 51 and 99 constituting lighting circuit 23 are arranged in distribution in spaces of case 3 and base member 17.

### TECHNICAL FIELD

The present invention relates to a lamp and a lighting apparatus for which a light-emitting element such as LED (Light-Emitting Diode) is used as the light source.

### BACKGROUND ART

In recent years, triggered by the practical use of super luminosity LEDs, there have been attempts to use, as the substitute for halogen bulbs, lamps having LEDs as the light source (Patent Literature 1).

In general, a halogen bulb (dichroic-beam-type) includes a reflection plate, an arc tube, and a base. The reflection plate includes a reflecting part and a projection. The reflecting part is in a conical shape and has a concave reflecting surface in its inner surface. The projection projects from the bottom of the reflecting part in a direction opposite to the reflecting surface. The arc tube is held by the projection in the state where it is positioned on the optical axis of the reflecting surface. The base is electrically connected with a filament coil contained in the arc tube, and is provided within the projection.

A lamp using the LED and intended to be a substitute for a halogen bulb (hereinafter, such a lamp is merely referred to as an “LED lamp”) includes a reflection plate and a base member like the halogen bulb, the reflection plate being conical and including a reflection surface, and the base member being hollow and projecting from the back face of the reflection plate. Furthermore, an LED is attached, as a light source, to the bottom of the reflection surface of the reflection plate, and a lighting circuit for lighting the LED is housed inside the base member.

With the above structure, the LED lamp can be attached to the conventional lighting equipment to which the halogen bulb is attached.

### CITATION LIST

### Patent Literature

### [Patent Literature 1]

Japanese Patent Application Publication No. 2009-093926

### [Patent Literature 2]

Japanese Patent Application Publication No. 2007-265892

### [Patent Literature 3]

Japanese Patent Application Publication No. 2010-045008

### SUMMARY OF INVENTION

### Technical Problem

Many halogen bulbs provide high brightness. Therefore, to substitute for the halogen bulbs, the LED lamps need to have an increased number of LEDs or increase the current that is applied to the LEDs.

However, a problem is that both of these necessities increase the size of the lighting circuit, making it difficult for the lighting circuit to be housed in the base member that has the same size as the base of the halogen bulb, and the lamp itself increases in size if it houses such a large lighting circuit.

It is therefore an object of the present invention to provide a lamp that realizes high brightness without increase in size.

### Solution to Problem

The above object is fulfilled by a lamp comprising: a light source including one or more light-emitting elements; a case in a shape of a cylinder having a bottom on whose inner surface the light source is arranged; a lens being smaller than the case in size and positioned in the case in a state where a light emission face of the lens is on an opening side of the case; a cover covering at least a space between the lens and the case; a base member being hollow inside and attached to an outer surface of the bottom of the case to project outside the case; and a circuit receiving electricity via the base member and causing the light source to emit light, electronic parts, which constitute the circuit, being arranged in inner spaces of the case and the base member in distribution.

In the above lamp, the lens may be in a shape of a truncated cone, a large diameter side thereof being on the opening side of the case, and a small diameter side thereof being on a light source side of the case, or, alternatively, one or more electronic parts arranged in the base member may generate a larger amount of heat than one or more electronic parts arranged in the case.

The above object is also fulfilled by a lighting apparatus comprising a lamp and lighting equipment to which the lamp has been attached in a detachable state, the lamp being the lamp defined as above.

### Advantageous Effects of Invention

In the lamp of the present invention, the electronic parts constituting the lighting circuit are arranged in inner spaces of the case and the base member in distribution. With this structure, even if all electronic parts cannot be stored in the base member due to increase of the parts for achieving the high brightness, electronic parts that fail to be stored therein can be stored in the case. This makes it possible to achieve the high brightness of the lamp without increase in size.

Also, in the lamp of the present invention, the lens is in the shape of a truncated cone, the large-diameter-side end of the lens is on the opening side of the case, and the small-diameter-side end is on the light source side of the case. This widens the space between the case and the lens, making it possible to use the space efficiently.

Furthermore, the electronic parts arranged in the base member may be electronic parts that generate a larger amount of heat than the electronic parts arranged in the case. This makes it easy for the heat to be transferred to the socket and the lighting equipment via the base.

Furthermore, by arranging electronic parts having a low heat resistance in the case, it is possible to keep the electronic parts having a low heat resistance away from the heat generated by the electronic parts that generate a larger amount of heat, thus preventing the circuit life from becoming short.

### BRIEF DESCRIPTION OF DRAWINGS

FIG. 1 is a perspective view of a lamp in Embodiment 1.

FIG. 2 is a perspective view of a longitudinal section of the lamp.

FIG. 3 is a plan view of the lamp from which the cover and lens have been removed.

FIG. 4 is a sectional view of the lamp taken along the line X-X of FIG. 3.

FIG. 5 is a perspective view for explanation of the wiring.

FIG. 6 illustrates an arrangement of lenses and electronic parts in Embodiment 2.

FIG. 7 is a view looking from the back of the cover.

FIG. 8 is a cutaway view of the case and base member.

FIG. 9 illustrates Modification 1 of the shape of the base member.

FIG. 10 is a schematic view for explanation of Modification 2 of Embodiment 2.

FIG. 11 is an exploded perspective view of a conventional lamp.

FIG. 12 is an exploded perspective view of a conventional lamp.

FIG. 13 is a perspective view of the lamp in Embodiment 3.

FIG. 14 is a sectional view of the lamp in Embodiment 3.

FIG. 15 is a perspective view of the lid in Embodiment 3.

FIG. 16 is an enlarged cross sectional view of a portion A encircled by a two-dot chain line in FIG. 14.

FIG. 17 is a sectional view of a lamp in Modification 1 of Embodiment 3.

FIG. 18 is a perspective view of the lid in Modification 1 of Embodiment 3.

FIG. 19 is a perspective view of another example of the lid in Modification 1 of Embodiment 3.

FIG. 20 is a sectional view of a lamp in Modification 2 of Embodiment 3.

FIG. 21 is an enlarged cross sectional view of a portion B encircled by a two-dot chain line in FIG. 20.

FIG. 22 is a perspective view of the lamp in Embodiment 4.

FIG. 23 is an exploded perspective view of the lamp in Embodiment 4.

FIG. 24 is a sectional view illustrating how the cover of Embodiment 4 is attached.

FIG. 25 is an exploded perspective view of the lamp in Modification of Embodiment 4.

FIG. 26 is a sectional view of a conventional lamp.

FIG. 27 is a perspective view of the lamp in Embodiment 5.

FIG. 28 is a sectional view of the lamp in Embodiment 5.

FIGS. 29A and 29B are perspective views of the optical member in Embodiment 5.

FIG. 30 is a sectional view of the lamp in Embodiment 6.

FIG. 31 is a sectional view of the lamp in Embodiment 7.

FIG. 32 is a sectional view of the lamp in Embodiment 8.

FIG. 33 is a sectional perspective view of a conventional lamp.

FIG. 34 is a perspective view of the lamp in Embodiment 9.

FIG. 35 is an exploded perspective view of the lamp in Embodiment 9.

FIG. 36 is an exploded perspective view of the lamp in Embodiment 9.

FIG. 37 is a perspective view of the cover in Embodiment 9 looking from the back.

FIG. 38 is a sectional view illustrating how the cover and case of Embodiment 9 are attached.

FIG. 39 is an enlarged cross sectional view of a portion indicated by sign A in FIG. 38.

FIG. 40 is a perspective view of the cover in Modification of Embodiment 9 looking from the back.

FIG. 41 is a sectional view illustrating how a hole is provided in the embodiment shown in FIG. 40.

FIG. 42 is a partially cutaway view illustrating the outline structure of the lighting apparatus in an embodiment of the present invention.

### DESCRIPTION OF EMBODIMENTS

The following embodiments explain examples of the lamp of the present invention with reference to the attached drawings.

### Embodiment 1

### 1. Overall Structure

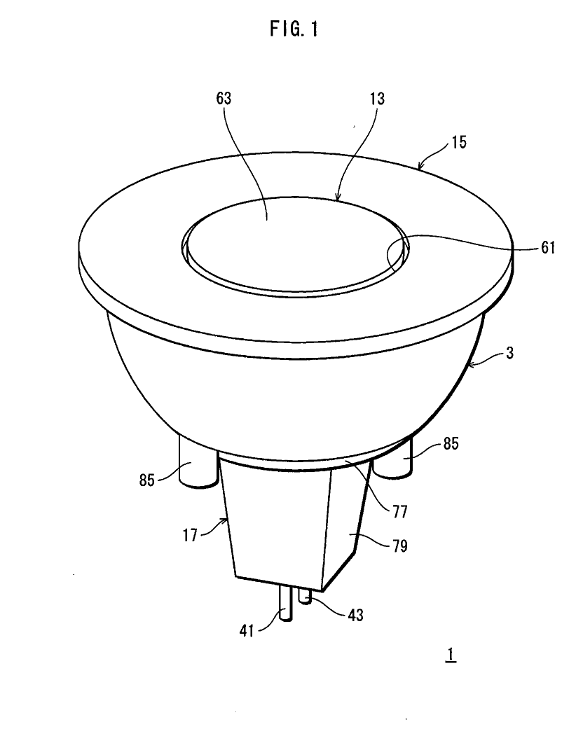

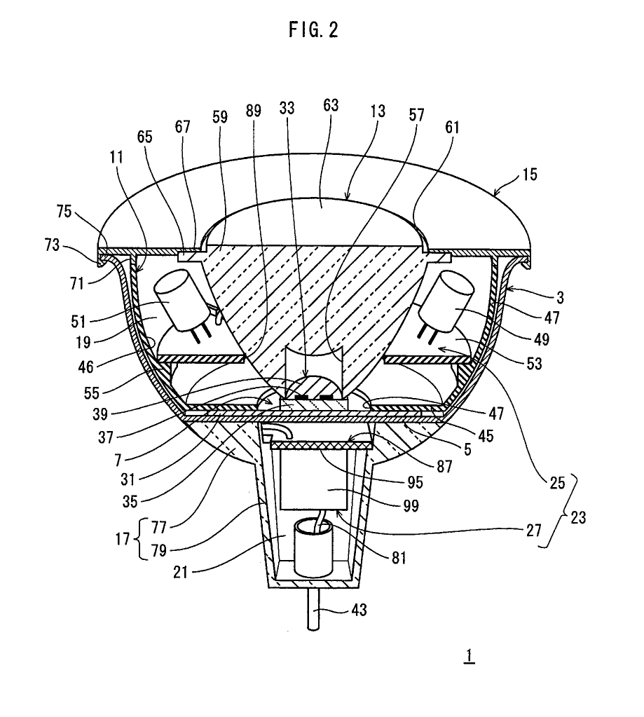

FIG. 1 is a perspective view of a lamp in Embodiment 1. FIG. 2 is a perspective view of a longitudinal section of the lamp.

The lamp 1 in Embodiment 1 is presumed to be a substitute for a halogen bulb, and it resembles a conventional mirrored halogen bulb in outer appearance.

The lamp 1 is a lamp which uses light-emitting elements (LEDs 37) as the light source. The lamp 1 includes a case 3, lens 13, a cover 15, a base member 17, and a circuit (lighting circuit 23). The case 3 is in a conical shape, and the light-emitting elements (LEDs 37) are installed on an inner surface of a bottom 5 of the case 3. The lens 13 is smaller than the case 3 in size and is positioned in the case 3 in the state where a light emission face 63 of the lens 13 is on the opening side of the case 3. The cover 15 has an opening 61 at its center, and is installed to cover the opening of the case 3 so that the light emission face 63 of the lens 13 is exposed through the opening 61. The base member 17 is hollow inside and is attached to the outer surface of the bottom 5 of the case 3 to project toward outside. The circuit (lighting circuit 23) receives electricity via the base member 17, and causes the light-emitting elements (LEDs 37) to emit light. Electronic parts (49, 51 and 99) constituting the circuit (lighting circuit 23) are arranged in distribution in spaces 19 and 21 of the case 3 and the base member 17.

That is to say, as illustrated in FIGS. 1 and 2, the lamp 1 includes the case 3, lens 13, an LED module 7, an insulation cup 11, the lens 13, the cover 15, the base member 17, and the lighting circuit 23. The case 3 is in a conical shape, with its one end being opened. The LED module 7 is mounted on the inner surface of the bottom 5 of the case 3. The conical insulation cup 11 is arranged along the inner surface of the case 3. The lens 13 is positioned above the LED module 7. The cover 15 covers the surface of an end of the case 3, except for the lens 13. The hollow base member 17 is attached to the back face of the case 3. The lighting circuit 23 includes the electronic parts that are arranged in distributed spaces: the space 19 between the insulation cup 11 and the lens 13; and the space 21 inside the base member 17.

Note that a part of the lighting circuit 23 arranged in the space 19 between the insulation cup 11 and the lens 13 is referred to as a first circuit part 25, and the remaining part of the lighting circuit 23 that is arranged in the space 21 inside the base member 17 is referred to as a second circuit part 27.

### 2. Components

### (1) Case 3

The case 3 is, as illustrated in FIG. 2, in a shape of a cylinder with a bottom and houses the insulation cup 11, the lens 13, the first circuit part 25, and the LED module 7 inside, and is, for example, in a conical shape where one end is opened and the other end (namely, the bottom 5) is flat.

The case 3 is made of a resin, metal or the like. In this example, the case 3 is made of aluminum by taking account of the heat resistance, heat dissipation, light weight and the like. Note that, if the case 3 is made of an insulating material (such as a resin or ceramic), the insulation cup 11 may not be necessary.

### (2) LED Module 7

The LED module 7, as illustrated in FIG. 2, includes a substrate 31 and an LED unit 33. The substrate 31 is made of aluminum, copper or the like. The LED unit 33 is implemented on the substrate 31. Note that, in the following, the substrate 31 of the LED module 7 is referred to as module substrate 31 so that it can be distinguished from other substrates such as the substrates 53 and 87 of the lighting circuit 23 which are described below.

The LED unit 33 is what is called a surface-mount type, and includes a substrate 35, one or more LEDs 37, and a sealing member 39 sealing the LEDs 37. Note that, in the following, the substrate 35 of the LED unit 33 is referred to as unit substrate 35 so that it can be distinguished from other substrates such as the substrates 31, 53, and 87. In this example, the LED unit 33 has four LEDs 37.

The sealing member 39 is made of a light transmissive material such as glass, epoxy-type resin, or silicone resin. The sealing member 39 is semispherical and seals the LEDs 37 in itself.

If necessary, the wavelength of the light from the LEDs 37 may be converted to a predetermined wavelength by mixing a wavelength converting member (for example, a phosphor) into the light transmissive material, or applying a phosphor layer to the surface of the light transmissive material.

### (3) Insulation Cup 11

The insulation cup 11 is provided to ensure the insulation between the case 3 and the lighting circuit 23, and is made of an insulating material such as a resin or ceramic.

The insulation cup 11 is arranged along the inner surface of the case 3, and, like the case 3, is in a conical shape in which one end is opened and the other (namely, a bottom 45) is flat. The bottom 45 has an opening 47 for the LED unit 33, and is in contact with the module substrate 31 of the LED module 7.

An inner circumferential wall 46 of the insulation cup 11 has supporting portions 55 for supporting a first substrate 53 for electronic parts 49 and 51 constituting the first circuit part 25. There are a plurality of (in this example, four) supporting portions 55, which are formed at predetermined intervals in a circumferential direction. The supporting portions 55 are projections extending toward the lamp axis. The surfaces of the projections on the opening side are formed to be flat, and the first substrate 53 is laid on the flat surfaces to be supported by the supporting portions.

### (4) Lens 13

The lens 13 causes beams of incident light from the LEDs 37 to be reflected, collected and output in a predetermined direction from the light emission face. In this example, the lens 13 is in the shape of a truncated cone, wherein a tip of the cone has been cut horizontally, and a hole 57, in which the sealing member 39 of the LED unit 33 is to be fit, is formed in an end surface of the lens 13 on the small diameter side, and an end 59 of the lens 13 on the large diameter side is fitted into the opening 61 of the cover 15.

An end face 63 on the large diameter side of the lens 13 is also the light emission face of the lamp 1 from which the light is emitted. The surface of the end face 63 has been processed to be uneven to have the light diffusion function.

A bottom face, namely a ceiling of the hole 57 located on the opposite side to the LED unit 33 (LEDs 37), is a convex lens whose center is expanded toward the LED unit 33 in the shape of an arc.

An end face 63 of the lens 13 on the LED unit 33 side (on the small diameter side) is flat and in contact with the surface of the unit substrate 35 of the LED unit 33, so that the light from the LEDs 37 is guided into the lens 13. This reduces the loss such as leakage of light and improves the efficiency.

The lens 13 has an extended portion 65 which is merely the thickness of the cover 15 away from the end face 63 on the large diameter side toward the small diameter side, and extends toward outside like a brim. The extended portion 65 fits into a dent 67 during the assembly process, the dent 67 being formed at the circumference of the opening 61, in the back face of the cover 15. With this structure, the outer surfaces of the cover 15 and the lens end face 63 (namely, the light emission face) are approximately included in a same plane, providing an excellent outer appearance.

The lens 13 is positioned and held by the mechanism where the hole 57 at the end on the small diameter side is restricted by the sealing member 39 of the LED unit 33, and the extended portion 65 on the large diameter side is restricted by the dent 67 of the cover 15. The lens 13, in this example, is made of acrylic (or may be made of polycarbonate, silicone resin, or glass).

### (5) Cover 15

The cover 15 has the opening 61 and a ring-like convex part 71, the opening 61 corresponding to the end 59 of the lens 13 on the large diameter side, and the ring-like convex part 71 projecting toward the bottom 45 to face the end surface of the insulation cup 11 on the opening side. In this example, the convex part is continuous in the circumferential direction. However, if a plurality of convex parts are provided at intervals in the circumferential direction, the same act can be obtained.

The cover 15 is attached to an end of the case 3 in the state where the end 59 of the lens 13 on the large diameter side is fit in the opening 61. With this structure, the lens 13 is held in the state where the light is emitted to outside of the lamp 1 from the light emission face.

The cover 15 holds the lens 13 by the dent 67 surrounding the opening 61, and holds the insulation cup 11 by the structure where the ring-like convex part 71 is in contact with (close to) the end surface of the insulation cup 11. The cover 15 is made of a non-light-transmissive material such as a synthetic resin (for example, polyethylene).

Note that the cover 15 is attached to the case 3 by, for example, forming the case 3 to flare out at the circumferential edge on the opening side, and causing a circumferential edge 73 of the cover 15 to engage with a circumferential edge 75 of the case 3.

### (6) Base Member 17

The base member 17 is attached to the case 3. The base member 17 includes a bottom part 77 and a projecting part 79, the bottom part 77 being in contact with the flat bottom 5 of the case 3, and the projecting part 79 projecting flatly from the bottom part 77 toward a direction opposite to the case 3. A base is provided in the projecting part 79.

The base in this example is a pin type (GU or GZ type), and a pair of base pins 41 and 43 constituting a power supply terminal extend from an end of the projecting part 79. Note that the base pins 41 and 43 are connected with the lighting circuit 23 via a wire 81.

The projecting part 79 is in the shape of a cylinder which is rectangular in a transverse section (that is to say, it is hollow, and the inner space thereof is the above-described space 21). In the space 21, electronic parts 99 constituting a second circuit part 27, which is a part of the lighting circuit 23, and the like are stored.

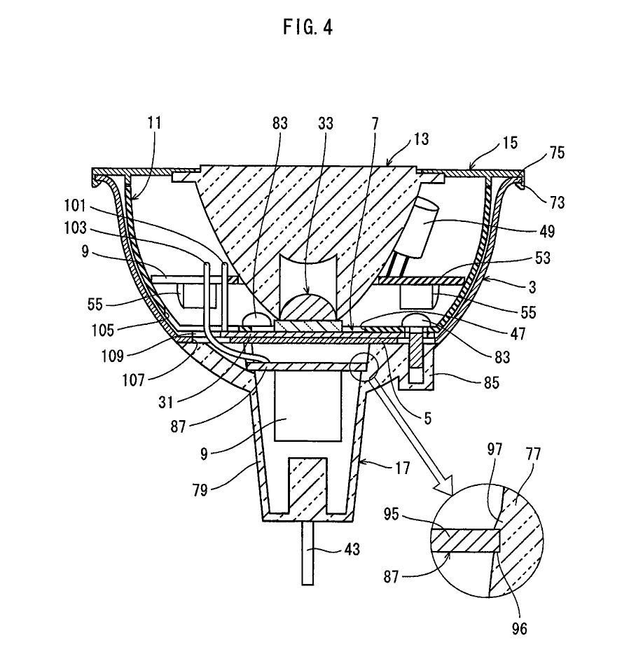

In this example, the base member 17 is fixed to the case 3 by three screws 83 (see FIG. 4). The screws 83 are screwed into screw receiving parts 85 which are provided in the bottom part 77 of the base member 17, protruding slightly from the surface of the bottom part 77 (see FIG. 4).

The screws 83 are passed through the insulation cup 11, LED module 7 and case 3, and screwed into the screw receiving parts 85 provided in the bottom part 77 of the base member 17. This causes the insulation cup 11, LED module 7 and case 3 to be positioned.

### (7) Lighting Circuit 23

The lighting circuit 23 receives power via the base pins 41 and 43 and causes the LEDs 37 of the LED unit 33, thereby lighting the lamp 1.

The lighting circuit 23, for example, may be (a) a lighting circuit provided with an inverter circuit for inputting the AC voltage and an output rectifier circuit and the like, or (b) a lighting circuit provided with a converter circuit and the like.

The circuit functions of the lighting circuit 23 can be realized by electronic parts that are implemented on the first substrate 53 and a second substrate 87, and are stored in a space 19 inside the case 3 and in the space 21 inside the base member 17.

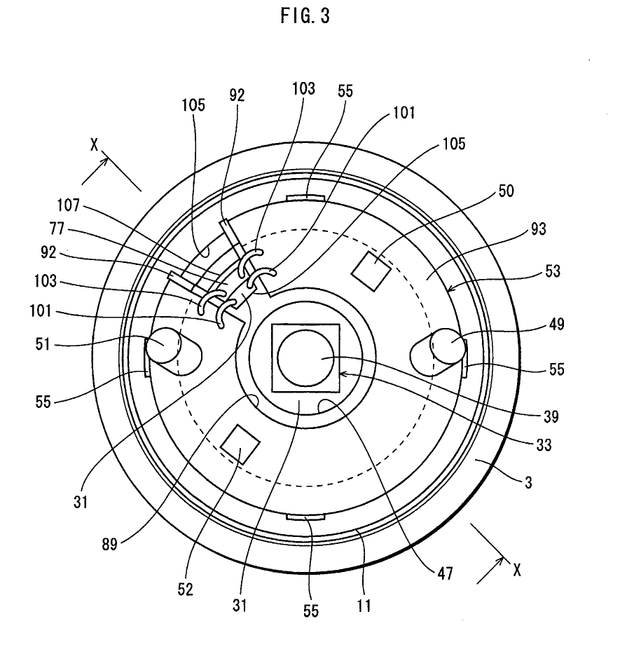

FIG. 3 is a plan view of the lamp 1 from which the cover 15 and lens 13 have been removed.

As illustrated in FIGS. 2 and 3, the first substrate 53 is composed of a ring-like flat plate 93 having a through hole 89 at its center and a cut 91 which is made by cutting a part of the ring-like flat plate 93 away in the circumferential direction.

The first substrate 53 is held inside the case 3 by the supporting portions 55 of the insulation cup 11 and the lens 13. That is to say, the movement of it toward the base member 17 is restricted by the supporting portions 55 of the insulation cup 11, and the movement of it toward the opening (cover 15) is restricted by the structure where a portion of the first substrate 53 surrounding the through hole 89 is in contact with the circumferential surface of the lens 13 that increases in diameter as it becomes closer to the opening, and the rotational movement of the first substrate 53 is restricted by a projection 92 that has been formed in correspondence with the position of the cut 91 of the first substrate 53 (or it may be fixed to the insulation cup 11 by a silicone adhesive or the like).

As illustrated in FIG. 2, the second substrate 87 is composed of a flat plate 95 which is in a rectangular shape in correspondence with the rectangular shape of the projecting part 79 in a transverse section. The inner wall of the base member 17 has a plurality of step-like differences 96, and above the step-like differences 96, projections 97 projecting toward the lamp axis are provided. With this structure, the second substrate 87 is supported by the step-like differences 96 and engages with the projections 97, and thereby held in the base member 17.

The electronic parts implemented on the second substrate 87 (namely, the electronic parts stored in the base member 17) are electronic parts that generate a larger amount of heat than the electronic parts 49 and 51 implemented on the first substrate 53 (namely, the electronic parts stored in the case 3).

More specifically, electronic parts such as electrolytic capacitors 49 and 51 constituting a smoothing circuit and switching elements 50 and 52 (transistors or the like) constituting an inverter circuit are implemented on the first substrate 53; and electronic parts that generate a large amount of heat, such as a coil 99 functioning as a noise filter, and a resistor, are implemented on the second substrate 87. Note that the coil, resistor and the like are highly heat-resistant parts as well.

### 3. Wiring

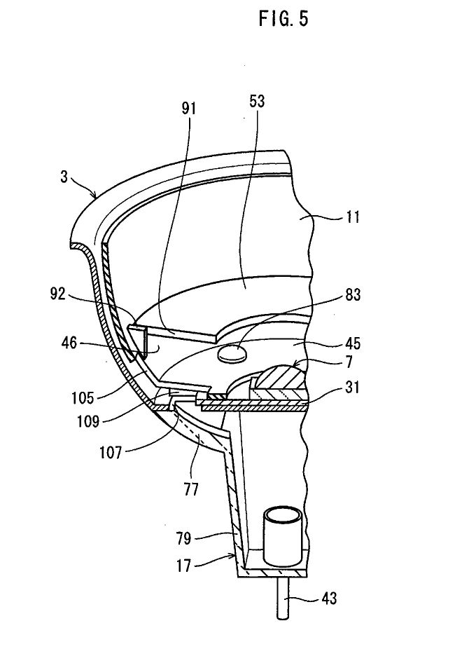

FIG. 4 is a sectional view taken along the line X-X of FIG. 3, looking in the direction of the arrows. FIG. 5 is a perspective view for explanation of the wiring. Note that illustration of wires is omitted in FIG. 5.

As shown in FIGS. 3 and 4, the first substrate 53 and the module substrate 31 are electrically connected with each other by a wire 101, and the first substrate 53 and the second substrate 87 are electrically connected with each other by a wire 103.

Also, as shown in FIGS. 3 through 5, the wire 101 passes through the cut 91 of the first substrate 53 and a wiring hole 105 formed in the bottom 45 and the inner circumferential wall 46 of the insulation cup 11; and the wire 103 passes through the cut 91 of the first substrate 53 similarly and the wiring hole 105 of the insulation cup 11 and a wiring hole 107 formed in the bottom 5 of the case 3. Note that the module substrate 31 has a cut 109 that is located below the wiring hole 105 of the insulation cup 11.

### 4. Effects

In the lamp 1 with the above structure, the electronic parts 49, 50, 51, 52 and the like that are a part of electronic parts (49, 50, 51, 52, 99 and the like) constituting the lighting circuit 23 are stored inside the case 3. With this structure, even if all electronic parts cannot be stored in the base member 17, electronic parts (49, 51) that fail to be stored therein can be stored in the case 3. This makes it possible to house the lighting circuit 23 in the lamp without increasing the size of the base member 17 and the case 3.

Among the electronic parts (49, 50, 51, 52, 99 and the like) constituting the lighting circuit 23, there are some parts, such as a resistor and a noise filter, that generate heat. Therefore if all electronic parts are stored in one place, use of electronic parts having a low heat resistance becomes difficult. The problem is solved by the present structure in which the electronic parts (50, 52 and the like) having a low heat resistance and the electronic parts that generate heat are stored separately in two distributed spaces.

### Embodiment 2

In Embodiment 1, one lens (the lens 13) is stored in the case 3. However, not limited to this, a plurality of lenses may be stored in the case. This applies to the LED unit as well.

The following describes, as Embodiment 2, a case where a plurality of (in this example, three) lenses are stored in the case.

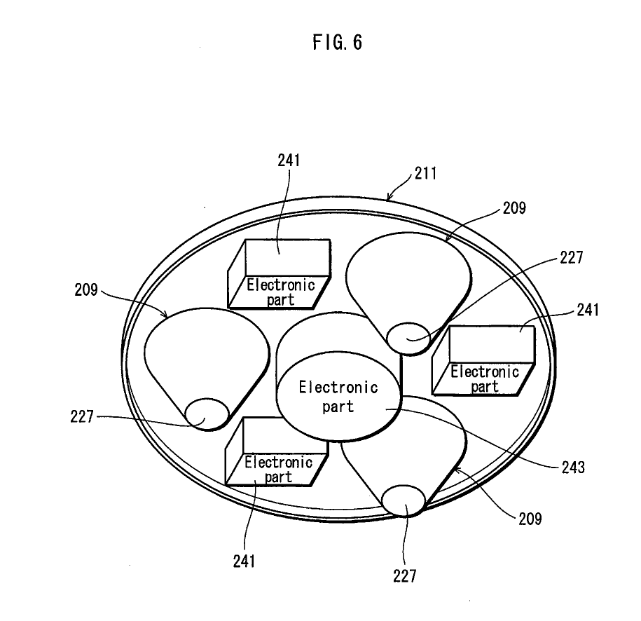

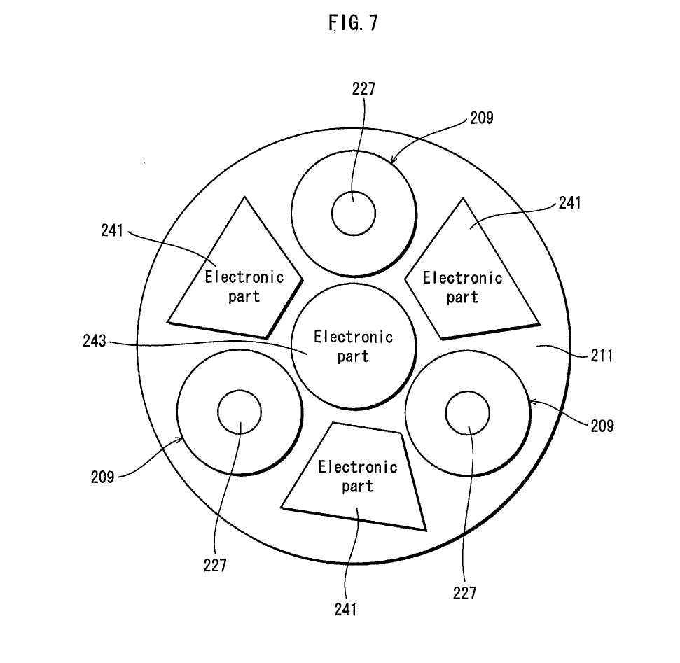

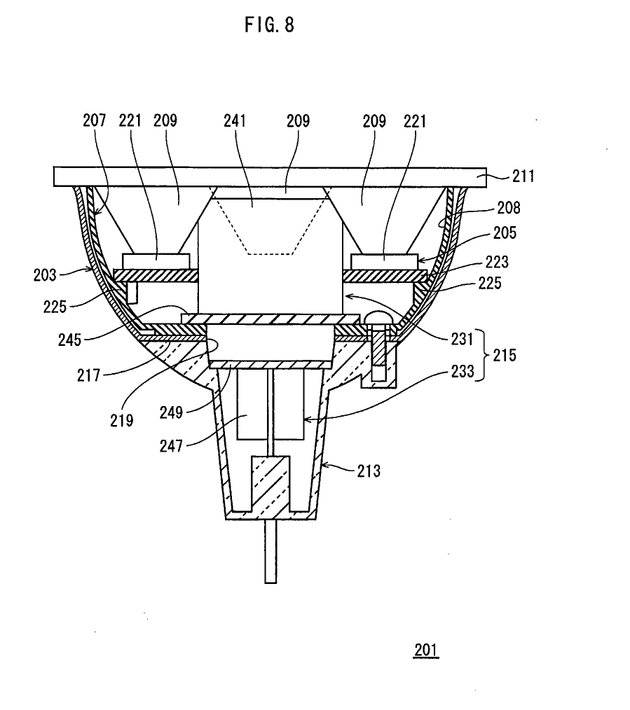

FIG. 6 illustrates an arrangement of lenses and electronic parts in Embodiment 2. FIG. 7 is a view looking from the back of the cover. FIG. 8 is a cutaway view of the case and base member. Note that FIGS. 6 through 8 illustrate the electronic parts conceptually, not concretely.

As shown in FIG. 8, a lamp 201 in Embodiment 2 includes a case 203, LED modules 205, an insulation cup 207, a plurality of (three) lenses 209, a cover 211, a base member 213, and a lighting circuit 215.

Like the case 3 in Embodiment 1, the case 203 is in a conical shape as a whole, and has a through hole 219 for wiring, at approximately the center of a bottom 217.

The LED modules 205 are provided with, on a module substrate 223, three LED units 221 in correspondence with the three lenses 209. More specifically, in three LED modules 205, three LED units 221 are implemented on a module substrate 223 at positions corresponding in a plan view to three vertices of an equilateral triangle whose center is the lamp axis. Note that each LED unit 221 has the same structure as the LED unit 33 in Embodiment 1.

The insulation cup 207, like the insulation cup 11 in Embodiment 1, is in a conical shape as a whole, and is arranged along the inner surface of the case 203.

An inner circumferential wall 208 of the insulation cup 207 has, at its central region (in the middle of the opening and the bottom along the lamp axis), supporting portions 225 for supporting the module substrate 223 on which the LED modules 205 are implemented. This enables the LED modules 205 to be arranged around the center of the case 203.

Like the lens in Embodiment 1, the lenses 209 are each in the shape of a truncated cone, and as shown in FIGS. 6 and 7, holes 227, in which sealing members of the LED units 221 are to be fit, are formed in end surfaces on the small diameter side. Also, three openings are provided in the cover 211 in correspondence with the lenses 209.

Each of the lenses 209 is held (positioned) in a similar manner to the lens in Embodiment 1. That is to say, a part of the LED unit 221 is fitted into the hole 227 of the lens 209 on the small diameter side, and an end of the lens 209 on the large diameter side is fitted into an opening of the cover 211.

As in Embodiment 1, the cover 211 is attached to the case 203 by making use of the engagement structure.

The base member 213 has the same structure as the base member in Embodiment 1.

The lighting circuit 215, as in Embodiment 1, includes a first circuit part 231 and a second circuit part 233, and electronic parts constituting the first circuit part and the second circuit part are arranged separately from each other. Namely, electronic parts 241 and 243 constituting the first circuit part 231 are arranged in the case 203, and an electronic part 247 constituting the second circuit part 233 is arranged in the base member 213.

That is to say, a part of the electronic parts constituting the lighting circuit 215 (electronic parts 241 and 243) is implemented on the first substrate 245 in the case 203, and the remaining part of the electronic parts (electronic part 247) is implemented on the second substrate 249 in the base member 213.

In Embodiment 2, since three lenses 209 are arranged at three vertices of a triangle as shown in FIGS. 7 and 8, there is a large space at the center of the lamp in a plan view (see FIG. 7).

Accordingly, the module substrate 223 is formed to have an opening in correspondence with the large space. This enables, as shown in FIG. 8, a large-sized electronic part (in this example, an electronic part 243) such as a choke coil to be arranged in a space in the case 203 approximately between the cover 211 and the bottom of the insulation cup 207.

### Modifications of Embodiments 1 and 2

Up to now, specific examples of the lamp of the present invention have been explained in Embodiments 1 and 2 (hereinafter, merely referred to as “the embodiments”). However, the lamp of the present invention is not limited to the embodiments. For example, the following modifications are considered.

### 1. LED Module

In the embodiments, each LED module (7, 205) is composed of an LED unit (33, 221) implemented on the module substrate (31, 223). However, not limited to this, the LEDs (37) may be implemented directly on the module substrate (31, 223). Furthermore, the module substrate may be divided into a plurality of substrates, and the LED unit(s) (33, 221) or the LEDs (37) may be implemented on each of the plurality of substrates.

In Embodiment 2, each of the LED units 221 is provided with the sealing member. However, a predetermined number of LEDs may be implemented directly on the module substrate, and these LEDs as a whole may be sealed in (covered with) one sealing member.

Also, in the embodiments, the LEDs are used as the light source. However, other light-emitting elements may be used. The other light-emitting elements include, for example, the semiconductor laser diode and the electroluminescence element.

The color of the light emitted by the light-emitting element is not limited to white, but may be any color of light. In that case, however, to obtain a desired color, a predetermined wavelength converter or the like is required.

### 2. Lighting Circuit

In the embodiments, the electrolytic capacitors 49 and 51, switching elements 50 and 52, and choke coil 243 are stored in the case (3, 203), and a coil functioning as a noise filter, a resistor and the like are stored in the base member (17, 213). However, the structure of the lighting circuit varies depending on the specifications and usage of each lamp, and thus is not limited to the structures explained in the embodiments, which are mere examples.

For example, when the lamp is used in a lighting apparatus that has a dimming function, a circuit structure for dimming is required. In that case, electronic parts constituting the circuit need to be arranged in the case and the base member appropriately. Of course, it is preferable to design the arrangement of electronic parts to be suited for the ambient temperatures in the case and base member, by taking account of the heat resistance and the like.

### (3) Base Member

### (1) Shape

In the embodiments, the shape of the base member is determined according to the shape of the halogen bulb. Accordingly, when the halogen bulb that is the target of substitute changes in shape, the shape of the base member changes as well from the shape described in the embodiments.

However, the shape of the base member may be changed within a range where the lamp can be loaded in the lighting apparatus.

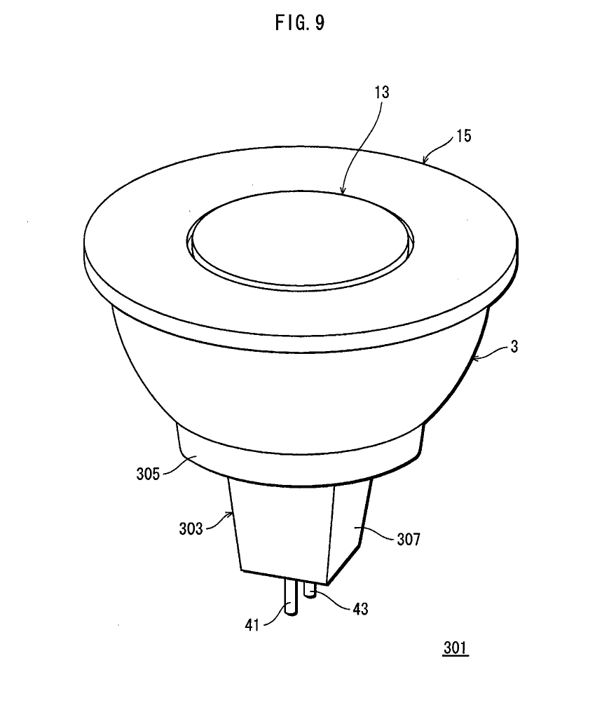

FIG. 9 illustrates Modification 1 of the shape of the base member.

A lamp 301 in Modification 1, as in Embodiment 1, includes the case 3, an LED module, an insulation cup, the lens 13, the cover 15, a base member 303, and a lighting circuit.

The base member 303 includes a cylindrical bottom part 305 and a projecting part 307 which is rectangular in a cross section. A base (base pins 41 and 43) is provided in the projecting part 307.

Even if the bottom part 305 differs in shape from the bottom part 77 of the base member 17 in Embodiment 1, it does not influence the attachment/detachment of the lamp 301 because the projecting part is plugged into the socket of the lighting apparatus.

Note that, since the bottom part 305 of the base member 303 in Modification 1 is formed to be in the cylindrical shape, the protrusions of the screw receiving parts 85 of the base member 17 can be removed.

### (2) Type

In the embodiments, a base of the GU or GZ type provided with a pair of base pins (41 and 43) is used in the base member (17, 213). However, not limited to this, bases of other types, such as E17, may be used.

Note that, when the base changes in type, the shape of the projecting part or the like changes from that in the embodiments.

### 4. Lens

In the embodiments, lens (13, 209) having the shape of a truncated cone is used. However, not limited to this, lenses having other shapes may be used based on the specifications and usage of the lamp. In that case, it should be noted that a space for storing the electronic parts constituting the lighting circuit needs to be present between the case and the lens when the lens is arranged in the case.

### 5. Cover

In the embodiments, the cover (15, 211) is made of a non-light-transmissive material, and has an opening so that the end face 63 on the large diameter side of the lens (13, 209) in the opening is exposed. However, not limited to this, the cover may be made of a light transmissive material and attached so that it covers the entire end surface on the large diameter side of the lens, or the cover may be mainly made of a non-light-transmissive material, with only a portion corresponding to the lens being made of a light transmissive material.

When the lens is covered as described above, the surface of a portion of the lens to be covered may be subject to an optical process so as to be uneven to have a function to diffuse the light, or may be subject to an optical process so as to be convex to have a function to collect the light.

### 6. First Substrate and Module Substrate

In the embodiments, the module substrate 31 of the LED module 7 and the first substrate 53 are provided as separate entities. However, not limited to this, a substrate arranged in the case may shared for those purposes. That is to say, the LED unit and electronic parts may be implemented on one substrate. In the following, an example of sharing a substrate is explained as Modification 2.

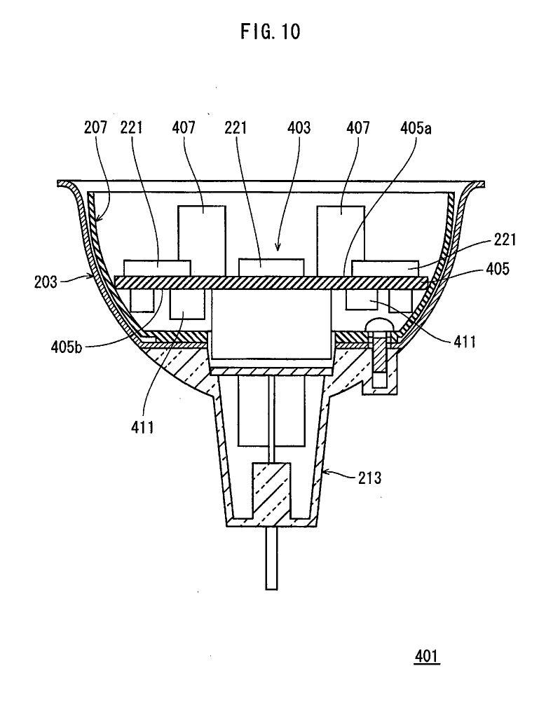

FIG. 10 is a longitudinal sectional view of a lamp in Modification 2.

A lamp 401 in Modification 2, as shown in FIG. 10, includes a case 203, LED modules 403, an insulation cup 207, a plurality of (three) lenses 209, a cover 211, a base member 213, and a lighting circuit 215.

Here, the case, insulation cup, lenses, cover, and base member in Modification 2 have the same structures as the case 203, insulation cup 207, lenses 209, cover 211, and base member 213 in Embodiment 2 and are assigned with the same reference signs.

As in Embodiment 2, in the LED modules 403, three LED units 221 are implemented on a substrate 405 in correspondence with three lenses.

On a front face 405a (the main surface on the cover side) of the substrate 405, the LED units 221 and a part of electronic parts 407 (for example, capacitors) constituting the lighting circuit 215 are implemented. On the other hand, a choke coil 409, switching elements 411 and the like are implemented on a back face 405b.

With the above structure, the electric wiring can be simplified, and the number of substrates can be reduced.

### 7. First Substrate and Second Substrate

In the embodiments, the first substrate (53, 245) is provided in the case (3, 203), and the second substrate (87, 249) is provided in the base member (17, 213). However, not limited to this, one substrate may be used as the first substrate (53, 245) and the second substrate (87, 249) (hereinafter, the one substrate is referred to as a “shared substrate”).

The above structure is realized by forming an opening at the center of the bottom of the case, and then, while assembling the case and the base member, setting the shared substrate between the case and the base member, implementing electronic parts constituting a first circuit on a main surface of the shared substrate facing the inside of the case, and implementing electronic parts constituting a second circuit on a main surface of the shared substrate facing the inside of the base member.

### Embodiment 3

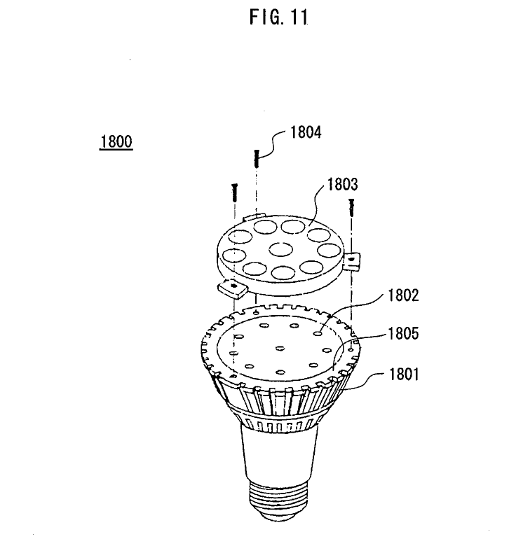

Patent Literature 2, a conventional technology, discloses a lamp 1800 in which, as illustrated in FIG. 11, a plurality of LEDs 1802 are loaded on an upper surface of a case 1801, and a lens member 1803 is fixed to the upper surface by screws 1804 to cover the LEDs 1802 and the upper surface. However, since an opening 1805 of the case 1801 is not covered by the lens member 1803, the lamp 1800 is inferior to the halogen bulb or incandescent bulb in outer appearance of the front view.

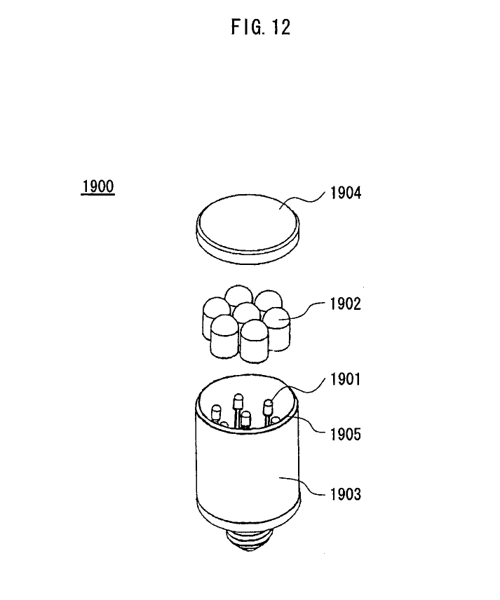

On the other hand, Patent Literature 3 discloses a lamp 1900 in which, as illustrated in FIG. 12, an opening 1904 of a case 1903 housing LEDs 1901 and lens members 1902 is covered by a cover 1904. With this structure, the lamp 1900 is as excellent as the halogen bulb or incandescent bulb in outer appearance of the front view.

However, the structure of the lamp 1900 increases the number of components since the cover 1904 is used, increasing the cost for raw materials and the number of assembly steps to increase the production cost.

In view of this, Embodiments 3 and 4 are aimed to provide a lamp which provides high brightness without increasing the size, and is excellent in outer appearance of the front view and is low in production cost.

In the lamps in Embodiments 3 and 4, the cover and lens are formed as one unit and constitute a lid that covers the opening of the case. This structure reduces the number of components, prevents the cost for raw materials and the number of assembly steps from increasing, restricting the increase in the production cost. Also, since the cover itself covers the opening of the case, it provides an excellent outer appearance in the front view.

The following Embodiments 3 and 4 explain examples of the lamp of the present invention with reference to the attached drawings. Note that in each of the drawings, the direction indicated by arrow X is a lamp lighting direction, and a face of the lamp viewed from the lamp lighting direction is the front face of the lamp.

(Schematic Overview of Lamp Structure in Embodiment 3)

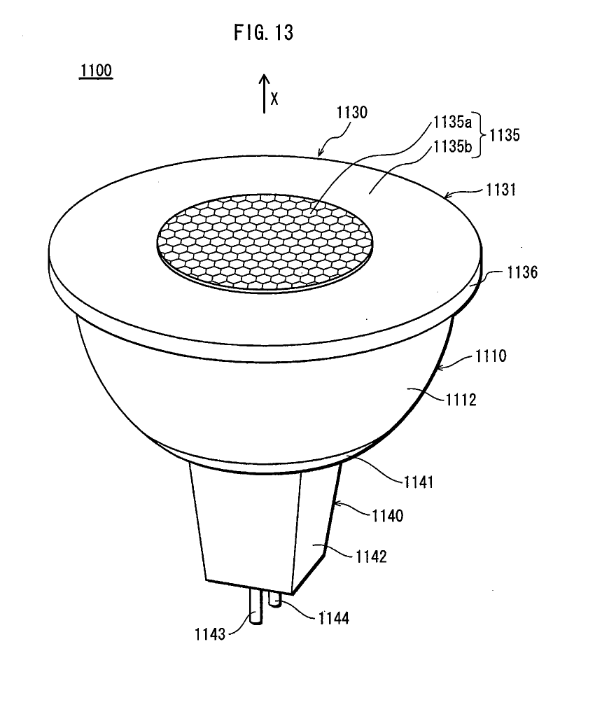

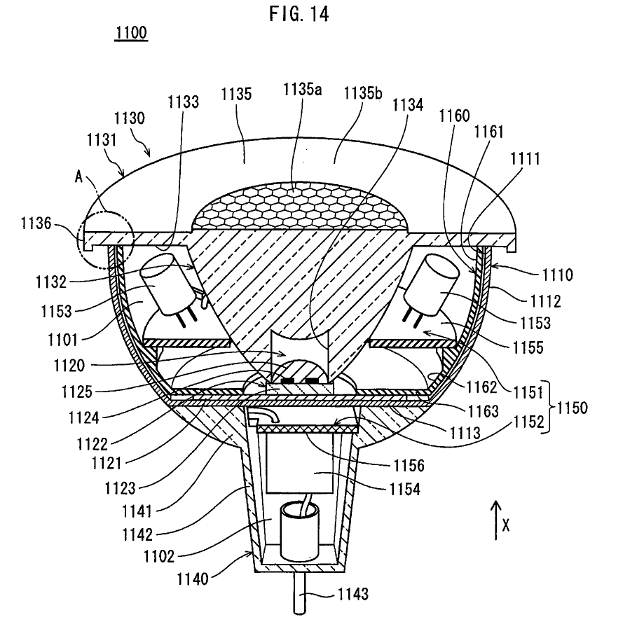

FIG. 13 is a perspective view of the lamp in Embodiment 3. FIG. 14 is a sectional view of the lamp in Embodiment 3. As illustrated in FIG. 13, a lamp 1100 in Embodiment 3 is a substitute for a halogen bulb having an outer appearance conforming to the standard for halogen bulb defined in “JIS C 7527”, and includes, as illustrated in FIG. 14, a case 1110, an LED module 1120, a lid 1130, a base member 1140, a circuit (lighting circuit) 1150, and an insulation member 1160.

(Case)

The case 1110, in a conical shape, has an opening 1111 on the front side, and includes a cylindrical portion 1112 and a bottom 1113 which closes the back side of the cylindrical portion 1112. The case 1110 houses the LED module 1120, a part of electronic parts constituting the lighting circuit 1150, and the insulation member 1160. The opening 1111 is provided to extract the light from the LED module 1120 to outside of the case 1110, and is closed by the lid 1130 that causes the light to pass through itself. As the material of the 1110, although resin, metal or the like can be adopted, aluminum is preferable when the heat resistance, heat dissipation, light weight and the like are taken into account.

(LED Module)

The LED module 1120 is the light source of the lamp 1100, includes a module substrate 1121 and an LED unit 1122 implemented approximately on the center of the module substrate 1121, and is mounted on the bottom 1113 of the case 1110. The LED unit 1122, for example, includes: a unit substrate 1123; LED chips 1124 of the InGaN type with blue emission light implemented on the unit substrate 1123; and a semispherical sealing member 1125 which contains a phosphor for emitting yellow-green light and seals the LED chip 1124 therein. The LED unit 1122 converts a part of blue light emitted from the LED chips 1124 to yellow-green by the phosphor, and emits white light that is generated as a mixture of blue light and yellow-green light.

(Lid)

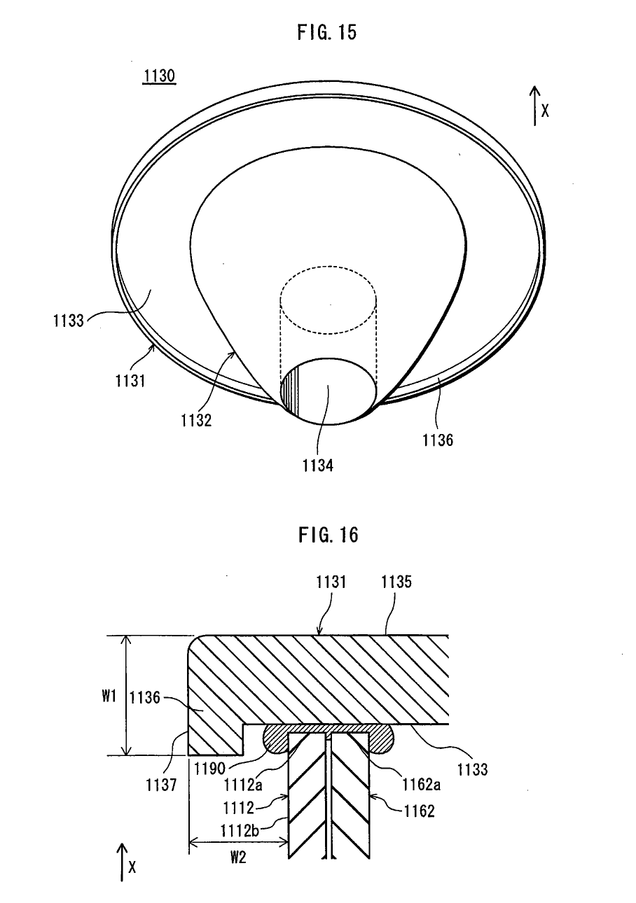

FIG. 15 is a perspective view of the lid in Embodiment 3. As shown in FIG. 15, the lid 1130 closing the opening of the case 1110, for example, includes a cover 1131 and a lens 1132 which are formed as one unit, wherein the cover 1131 is in the shape of an approximately circular plate and covers the outer circumference of the opening 1111 of the case 1110, and the lens 1132 is in the shape of a truncated cone, wherein a tip of the cone has been cut horizontally. Note that the cover 1131 and the lens 1132 being formed as one unit means that the lid 1130 itself is a part in the smallest unit, not manufactured by combining parts to be the cover 1131 and the lens 1132. With the above structure having the cover 1131 and the lens 1132 formed as one unit, the lamp 1100 has a small number of components and is produced at a low cost.

Back to FIG. 14, the lid 1130 is attached to the case 1110 so that the cover 1131 covers the entire front surface of the case 1110, and the lens 1132 is placed between the cover 1131 and the LED module 1120.

FIG. 16 is an enlarged cross sectional view of a portion A encircled by a two-dot chain line in FIG. 14. Here, how the lid 1130 is attached is explained in more detail. As shown in FIG. 16, a back face (a face facing the case 1110) 1133 of the cover 1131 is bonded by an adhesive 1190 to a front-side end 1112a of the cylindrical portion 1112 of the case 1110. The adhesive 1190 also bonds a back face 1133 of the cover 1131 to a front-side end 1162a of a cylindrical portion 1162 of the insulation member 1160. Note that the adhesive 1190 may be applied to all over the circumference of the front-side end 1112a of the cylindrical portion 1112, or may be applied to a plurality of positions with intervals therebetween.

With the above structure where the lid 1130 is attached with use of the adhesive 1190, the lamp 1100 has an excellent outer appearance. That is to say, if the screws are used to attach the cover to the case, the heads of the screws are exposed on the surface of the lamp, resulting in disfigurement of the lamp. The lamp 1100 does not suffer from the disfigurement. Also, the structure eliminates the need to provide the screw receiving part in the case 1110. This prevents the lamp from having a complicated shape, being thick or heavy, or having a decreased internal volume.

Back to FIG. 14, the lens 1132 projects toward the LED module 1120 from approximately the center of the cover 1131, and at the tip of the projection, a concave 1134 in the shape of approximate cylinder is provided. By fitting a sealing member 1125, which is a dome-like projection of the LED unit 1122, into the opening of the concave 1134, the position of the lid 1130 is determined relative to the LED module 1120.

The lid 1130 is made of, for example, a transparent acrylic resin, and the light from the LED module 1120 passes through the lid 1130, and is extracted to outside of the case 1110.

The emitted light enters the lens 1132 mainly from the concave 1134, passes through the lens 1132, further passes through the cover 1131, is diffused by a light diffusion working region 1135a in a front surface 1135 of the cover 1131, and is extracted to outside of the case 1110. The lens 1132 functions as a lens that focuses the emitted light. Thus the light becomes a spotlight after passing through the lens 1132. The light diffusion working region 1135a is formed in the shape of approximately a circle, at approximately the center of the front surface 1135 of the cover 1131 (which doubles as the front surface of the lid 1130), in correspondence with the position of the lens 1132, and is provided with a plurality of convexes and concaves for diffusing the light.

On the other hand, the light that leaks from the lens 1132 into a first space 1101, which is described below, passes through the cover 1131, and is ejected to outside of the case 1110 via a non-working region 1135b in the front surface 1135 of the cover 1131. The non-working region 1135b is a plate with an even surface formed in the shape of an approximate ring to surround the light diffusion working region 1135a in the front surface 1135 of the cover 1131. In this structure, since the light is extracted not only from the light diffusion working region 1135a, but also from the non-working region 1135b as described above, light is emitted from approximately the entire front surface 1135 of the cover 1131.

The material of the lid 1130 is not limited to the transparent acrylic resin, but is preferably a light transmissive material such as a light transmissive resin other than acrylic, a light transmissive ceramic, or glass.

The lid 1130 is not necessarily made of the same material, but may be made of two or more different materials. For example, the cover 1131 and the lens 1132 may be made of different materials. Also, in the cover 1131, the light diffusion working region 1135a and the non-working region 1135b may be made of different materials. It should be noted however that, even if the lid 1130 is made of two or more different materials, the cover 1131 and the lens 1132 need to be formed as one unit.

Furthermore, the lid 1130 does not need to be made of a light transmissive material in its entirety, but it is sufficient that at least portions of the lens 1132 and the cover 1131 corresponding to the light diffusion working region 1135a are made of a light transmissive material. That is to say, portions corresponding to the non-working region 1135b of the cover 1131 do not need to be made of a light transmissive material.

When portions corresponding to the non-working region 1135b are made of a non-light-transmissive material, the outer appearance is excellent in that the lighting circuit 1150 and the like housed in the case 1110 cannot be seen through the portions. Note that, even if the portions corresponding to the non-working region 1135b are made of a light transmissive material, non-light-transmissive paint may be applied to the non-working region 1135b, or a sheet of non-light-transmissive material may be put on the non-working region 1135b so that the lighting circuit 1150 and the like cannot be seen through the lid 1130.

As shown in FIG. 16, an outer circumferential portion 1136 of the cover 1131 is thicker than the other portions. The thickness (width in the front and back direction) W1 of the outer circumferential portion 1136 is in the range from 1.8 mm to 2.4 mm. Also, width W2 of a circumferential portion of the cover 1131 protruding from the case 1110 (a distance between a circumferential surface 1137 of the cover 1131 and an outer circumferential surface 1112b of the cylindrical portion 1112 in a direction perpendicular to the axis of the cylindrical portion 1112) is at least 0.7 mm. The lamp 1100 can be attached to the lamp fitting for the halogen bulb since both thickness W1 and width W2 conform to the JIS C 7527 standard.

(Base Member)

Back to FIG. 14, the base member 1140 is a base member for supplying power to an LED module having the shape defined in the JIS C 7709 standard that can be adapted to the socket for halogen bulb. The base member 1140 includes a bottom part 1141 and a projecting part 1142. The bottom part 1141 is attached to a bottom 1113 of the case 1110. The projecting part 1142 projects flatly from the bottom part 1141 toward the back side. To the projecting part 1142, a pair of base pins 1143 and 1144, which are electrically connected with the lighting circuit 1150, are attached. The projecting part 1142 is in the shape of a cylinder which is rectangular in a transverse section, and has inside a second space 1102 housing a second circuit 1152 of the lighting circuit 1150.

### (Lighting Circuit)

The lighting circuit 1150, for example, may be a lighting circuit provided with: a rectifier circuit that rectifies an AC power supplied from a commercial power source to a DC power; and a voltage adjustment circuit that adjusts a voltage value of the DC power rectified by the rectifier circuit. The lighting circuit 1150 is electrically connected with an LED unit 1122 and the base pins 1143 and 1144 of the base member 1140, receives power via the base pins 1143 and 1144, and causes LEDs 1124 of the LED unit 1122 to emit light.

The lighting circuit 1150 is composed of a first circuit 1151 and a second circuit 1152. The first circuit 1151 is housed in the first space 1101 between the insulation member 1160 and the lens 1132. The second circuit 1152 is housed in the second space 1102 inside the projecting part 1142 of the base member 1140. The functions of each circuit of the lighting circuit 1150 can be realized by a plurality of electronic parts 1153 and 1154. The plurality of electronic parts 1153 and 1154 are implemented, in distribution, on a first substrate 1155 of the first circuit 1151 and a second substrate 1156 of the second circuit 1152.

Note that electronic parts with low heat resistance are housed in the first space 1101, and electronic parts with high heat generation are housed in the second space 1102. More specifically, electronic parts such as electrolytic capacitors constituting a smoothing circuit and switching elements (transistors or the like) constituting an inverter circuit are implemented on the first substrate 1101; and electronic parts such as a coil functioning as a noise filter, and a resistor, are implemented on the second substrate 1102.

In this way, by housing the electronic parts 1153 and 1154 in distributed places, it is possible to house the lighting circuit 1150 in the lamp without increasing the size of the base member 1140 and the case 1110. Among the electronic parts constituting the lighting circuit 1150, there are some parts, such as a resistor and a noise filter, that generate heat. In this structure, the electronic parts having a low heat resistance and the electronic parts that generate heat are stored separately in two distributed spaces.

Electronic parts that generate small amounts of heat are stored in the first space. With this structure, even if the lid 1130, which is composed of the cover 1131 and the lens 1132 that are formed as one unit, is made of a material having a relatively low heat resistance, such as acrylic resin, the cover 1131 and the lens 1132 are not deformed.

(Insulation Member)

The insulation member 1160 is in a conical shape, having an opening 1161 on the front side. The insulation member 1160 includes a cylindrical portion 1162 and a bottom 1163. The bottom 1163 is in the shape of a circular plate and closes the back side of the cylindrical portion 1162. The insulation member 1160 is slightly smaller than the case 1110, and is arranged along the inner surface of the case 1110. The insulation member 1160 has a function to ensure the insulation between the lighting circuit 1150 and the case 1110, and is made of an insulation material such as silicon resin or ceramic. Note that if the case 1110 is made of an insulation material such as resin or ceramic, the insulation member 1160 may not necessarily be required.

### Modification 1

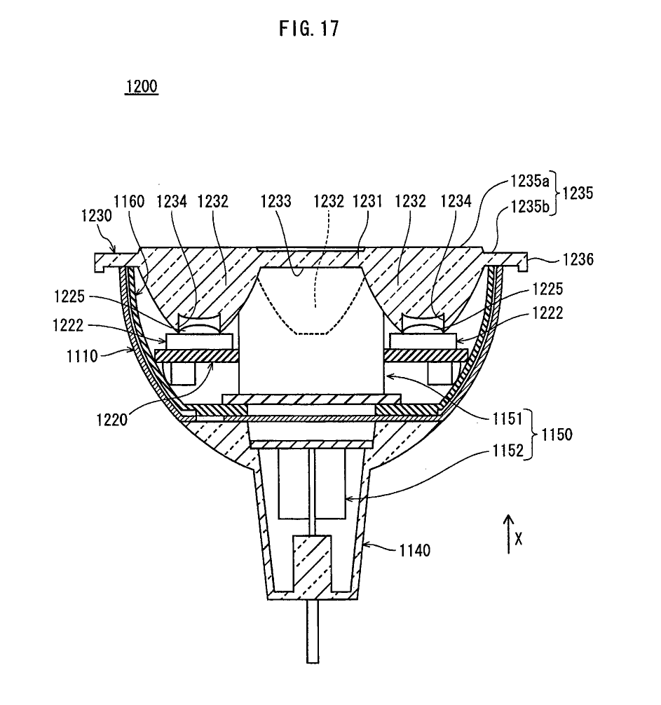

FIG. 17 is a sectional view of a lamp in Modification 1 of Embodiment 3. As shown in FIG. 17, a lamp 1200 in Modification 1 of Embodiment 3 differs from the lamp 1100 in Embodiment 3 in that an LED module 1220 includes a plurality of LED units 1222 and a lid 1230 includes a plurality of lenses 1232. In the following, the LED module 1220 and the lid 1230 are mainly explained, and to avoid redundancy, explanation of similarities to Embodiment 3 is omitted. Note that structural elements that are the same as those of Embodiment 3 are assigned the same reference signs.

The LED module 1220 is the light source of the lamp 1200, and, for example, includes a module substrate 1221 and three LED units 1222. The three LED units 1222 are implemented on a module substrate 1223 at positions corresponding in a plan view to three vertices of an equilateral triangle whose center is the lamp axis. Note that each LED unit 1222 has the same structure as the LED unit 1122 in Embodiment 1.

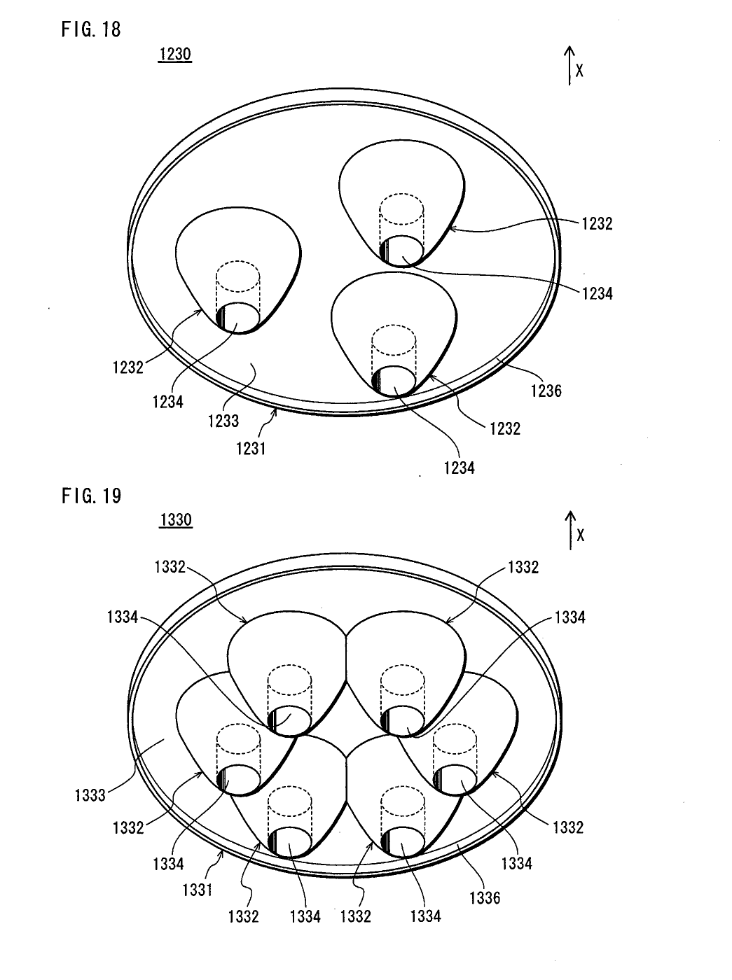

FIG. 18 is a perspective view of the lid in Modification 1 of Embodiment 3. As shown in FIG. 18, the lid 1230, for example, includes a cover 1231 and three lenses 1232 that are formed as one unit. The cover 1231 is in the shape of an approximately circular plate, and an outer circumferential portion 1236 thereof is thicker than the other portions. Each of the three lenses 1232 is in the shape of a truncated cone whose tip has been cut horizontally, includes a concave 1234, and extends from a back face 1233 of the cover 1231.

The three lenses 1232 are arranged at positions corresponding to the three LED units 1222 of the LED module 1220. Regions in a front surface 1235 of the cover 1231 corresponding to the three lenses 1232 are light diffusion working regions 1235a that have been processed to have the light diffusion function, and the other regions of the front surface 1235 are non-working regions 1235b that have not been processed to have the light diffusion function.

The lid 1230 is attached to the case 1110 in the state where it covers the LED module 1220 and an outer circumference of an opening 1111 of the case 1110, with the back face 1233 of the cover 1231 being in contact with the case 1110. As in Embodiment 1, the lid 1230 is positioned relative to the LED module 1220 by fitting sealing members 1225 of the LED units 1222 into the concaves 1234 of the lenses 1232.

As described above, a plurality of lenses 1232 may be provided in correspondence with the number of LED units 1222. Accordingly, if six LED units are present, a lid 1330 shown in FIG. 19 may be formed. The lid 1330 includes a cover 1331 and six lenses 1332 that are formed as one unit. The cover 1331 is in the shape of an approximately circular plate whose outer circumferential portion is thicker than the other portions. Each of the six lenses 1332 is in the shape of a truncated cone whose tip has been cut horizontally, includes a concave 1334, and extends from a back face 1333 of the cover 1331. With the above structure where a plurality of lenses 1232 are provided in one-to-one correspondence with a plurality of LED units 1222, the lights emitted from the LED units 1222 are focused more efficiently.

### Modification 2

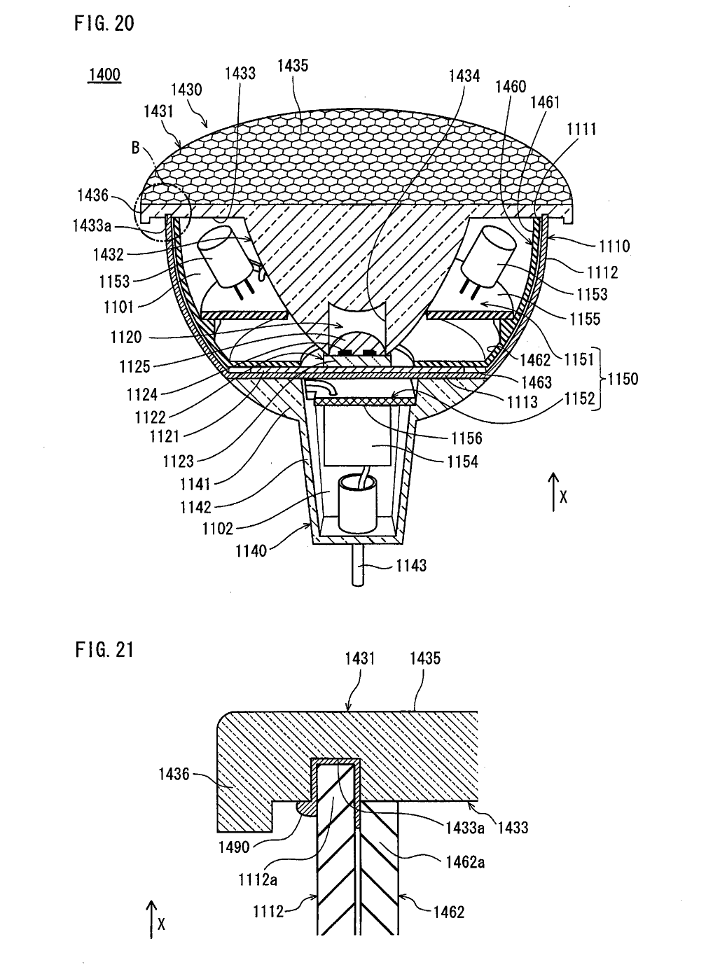

FIG. 20 is a sectional view of a lamp in Modification 2 of Embodiment 3. As shown in FIG. 20, a lamp 1400 in Modification 2 of Embodiment 3 differs from the lamp 1100 in Embodiment 3 in the structure of a lid 1430. In the following, differences are mainly explained, and to avoid redundancy, explanation of similarities to the lamp 1100 in Embodiment 3 is omitted. Note that structural elements that are the same as those of Embodiment 3 are assigned the same reference signs.

As shown in FIG. 20, the lid 1430 of the lamp 1400 in Modification 2 of Embodiment 3 includes a cover 1431 and a lens 1432 that are formed as one unit. The cover 1431 is in the shape of an approximately circular plate, wherein an outer circumferential portion 1436 thereof is thicker than the other portions. The cover 1431 covers an outer circumference of the opening 1111 of the case 1110. The lens 1432 is in the shape of a truncated cone whose tip has been cut horizontally, includes a concave 1434, and extends from a back face 1433 of the cover 1431. The lid 1430 is attached to the front-side end 1112a of the cylindrical portion 1112 of the case 1110 so as to cover the entire front surface of the case 1110, and the lens 1432 is placed between the cover 1431 and the LED module 1120.

The lid 1430 is made of, for example, transparent acrylic resin, and a front surface 1435 of the cover 1431, in its entirety, has been processed to have the light diffusion function for preventing the glare. This structure enables the light emitted from the LED module 1120 to be extracted from the entire front surface of the lamp 1400 in a light distribution pattern that is closer to that of the incandescent lamp with a reflecting mirror. Furthermore, since the entire front surface 1435 of the cover 1431 has been processed to have the light diffusion function, the lighting circuit 1150 and the like housed in the case 1110 are difficult to be seen through the lid 1430.

FIG. 21 is an enlarged cross sectional view of a portion B encircled by a two-dot chain line in FIG. 20. As shown in FIG. 21, in the lid 1430, a fitting groove 1433a as a fitting portion is provided in the back face 1433 of the cover 1431. The fitting groove 1433a is formed in the shape of a ring in correspondence with the front-side end 1112a of the cylindrical portion 1112 of the case 1110, and the width of the groove is slightly larger than the thickness of the cylindrical portion 1112.

The lid 1430 can be easily positioned relative to the case 1110 by fitting the front-side end 1112a of the case 1110 into the fitting groove 1433a. Before the lid 1430 is attached to the case 1110, an adhesive 1490 may be filled in the fitting groove 1433a so that the lid 1430 is bonded to the case 1110.

The insulation member 1460 is in a conical shape, having an opening 1461 on the front side. The insulation member 1460 includes a cylindrical portion 1462 and a bottom 1463. The bottom 1463 is in the shape of a circular plate and closes the back side end of the cylindrical portion 1462. The insulation member 1460 is slightly smaller than the case 1110, and is arranged along the inner surface of the case 1110. A front-side end 1462a of the cylindrical portion 1462 of the insulation member 1460 is positioned on more back side than the front-side end 1112a of the cylindrical portion 1112 of the case 1110, and the front-side end 1462a of the insulation member 1460 is in contact with the back face 1433 of the cover 1431 in the state where the front-side end 1112a of the case 1110 is fitted in the fitting groove 1433a, and is bonded to the back face 1433 by the adhesive 1190 that bonds the case 1110 to the lid 1430.

### Embodiment 4

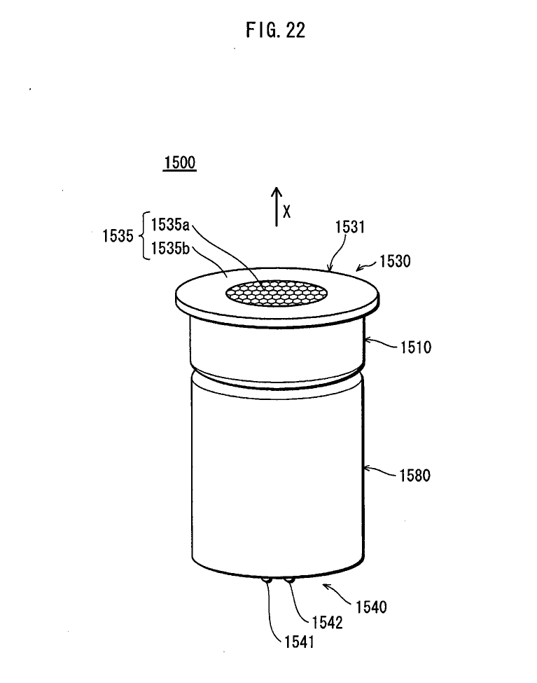

FIG. 22 is a perspective view of the lamp in Embodiment 4. As shown in FIG. 22, a lamp 1500 in Embodiment 4 is a spotlight having an outer appearance of an approximate cylinder, and since the lamp 1500 is partially common to the halogen bulb defined in the JIS C 7527 standard in shape, it can be used as a substitute for the halogen bulb.

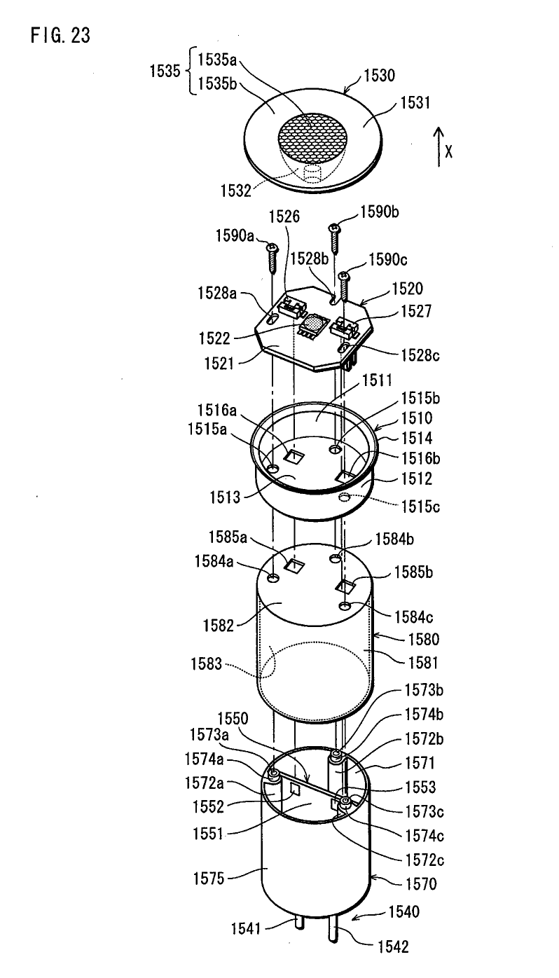

FIG. 23 is an exploded perspective view of the lamp in Embodiment 4. As shown in FIG. 23, a lamp 1500 includes a case 1510, an LED module 1520, a lid 1530, base pins 1540, a circuit (lighting circuit) 1550, a circuit housing part 1570, a heat sink 1580 and the like.

(Case)

The case 1510 is, for example, a cylindrical member with a bottom and has an opening 1511 on the front side. The case 1510 includes a cylindrical portion 1512 and a bottom 1513 which is in the shape of a circular plate and closes the lower end of the cylindrical portion 1512. The case 1510 is made of a material that has excellent heat radiation, such as a metal or ceramic (including glass). A flange 1514, as an engaging portion, is provided at the front-side end of the cylindrical portion 1512. In the bottom 1513, three approximately circular screw insertion holes 1515a through 1515c and two approximately rectangular connector insertion holes 1516a and 1516b are formed.

Note that, when the case 1510 is made of an electrically conductive material, it is preferable that an insulation case or the like is provided inside the case 1510 to ensure the insulation between the case 1510 and electronic parts arranged in the inner space of the case 1510.

(LED Module)

The LED module 1520 is the light source of the lamp 1500, and includes an implementation substrate 1521, an LED unit 1522, and a pair of connectors 1526 and 1527.

The implementation substrate 1521 is, for example, a plate in the shape of an approximate octagon which is composed of: a metal plate made of aluminum or the like on which an insulation layer made of thermally conductive resin is formed; a wiring pattern (not illustrated) formed on the insulation layer to be electrically connected with the LEDs; and three screw insertion holes 1528a through 1528c formed at positions not overlapping with the wiring pattern. As the substrate structure, the substrate may include a ceramic plate on which a wiring pattern is formed to be electrically connected with the LEDs. Note that the screw insertion holes 1528a through 1528c are elongated holes that broaden in the same direction in width, so that, when the LED module 1520 is fixed by the screws, the LED module 1520 can be shifted in position along the elongated holes.

The LED unit 1522, for example, has approximately the same structure as the LED unit 1122 in Embodiment 3. The LED unit 1522 is implemented on the implementation substrate 1521, and is electrically connected with the wiring pattern (not illustrated) on the implementation substrate 1521.

The connectors 1526 and 1527 are fixed to the implementation substrate 1521 in the state where they have passed through the implementation substrate 1521, and are electrically connected with the wiring pattern on the implementation substrate 1521.

(Lid)

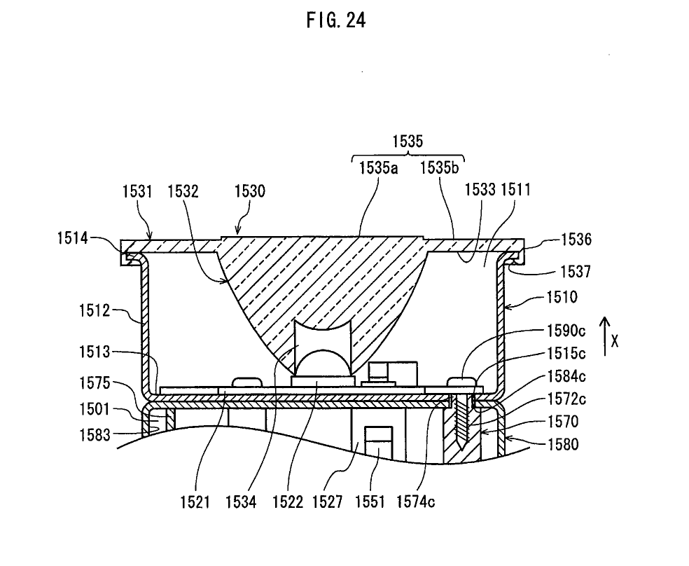

FIG. 24 is a sectional view illustrating how the cover of Embodiment 4 is attached. The lid 1530 covering the opening of the case 1510 is made of transparent acrylic resin, and, as shown in FIG. 24, includes a cover 1531 and a lens 1532 that are formed as one unit. The cover 1531 is in the shape of an approximately circular plate, has an outer circumferential portion 1536 that is thicker than the other portions, and covers the outer circumference of the opening 1511 of the case 1510. The lens 1532 is in the shape of a truncated cone whose tip has been cut horizontally, includes a concave 1534, and extends from a back face 1533 of the cover 1531. A front surface 1535 of the cover 1531 is composed of a light diffusion working region 1535a that has been processed to have the light diffusion function, and a non-working region 1535b that has not been processed to have the light diffusion function.

The lid 1530 differs from the lid 1130 of Embodiment 3 in that an engaging claw 1537 is provided as an engaging portion at an outer circumference 1536 of the cover 1531. The engaging claw 1537 is provided over the whole circumference of the outer circumference 1536 to project from a back-side end of the outer circumference 1536 toward the inside. Note that the engaging claw 1537 may have a structure in which a plurality of engaging claws are provided at intervals over the whole circumference of the outer circumference 1536. In that case, the lid 1530 can be attached and detached easily.

(Base Member)

Back to FIG. 23, the base member includes a circuit housing part 1570 and base pins 1540.

The base pins 1540 are composed of base pins 1541 and 1542 conforming to “GU5.3” defined in JIS C 7709 standard and adaptable to the socket for halogen bulb. The base pins 1541 and 1542 are installed to protrude from the bottom of the circuit housing part 1570, and are electrically connected with the lighting circuit 1550. Note that the bases in Embodiments 3 and 4 are not limited to pin bases of “GU5.3”, but may be pin bases of “GU10” or E bases of “E26” or the like.

The circuit housing part 1570, for example, is in the shape of a cylinder with a bottom, wherein the lower end is closed and the upper end is opened, and is made of an insulation material such as resin or ceramic. The lighting circuit 1550 is housed in the circuit housing part 1570. On an inner circumferential surface 1571 of the circuit housing part 1570, three protrusions 1572a through 1572c are provided at regular intervals in the circumferential direction. Also, convexes 1574a through 1574c in the shape of approximate cylinder having screw holes 1573a through 1573c are formed on the front side of the protrusions 1572a through 1572c.

(Lighting Circuit)

The lighting circuit 1550, for example, may be a lighting circuit provided with: a rectifier circuit that rectifies an AC power supplied from a commercial power source to a DC power; and a voltage adjustment circuit that adjusts a voltage value of the DC power rectified by the rectifier circuit. The lighting circuit 1550 causes the LED module 1520 to emit light, by using the commercial power source.

Electronic parts (not illustrated) constituting the lighting circuit 1550 are arranged in the inner space of the case 1510 and the inner space of the circuit housing part 1570. The lighting circuit 1550 includes a circuit substrate 1551 which is a rectangular plate and on which a plurality of electronic parts (not illustrated) such as a diode, electrolytic capacitor, coil, and resistor are implemented. On the circuit substrate 1551, terminals 1552 and 1553, which are electrically connected with the connectors 1526 and 1527 of the LED module 1520, are provided.

(Heat Sink)

The heat sink 1580 includes a cylindrical part 1581 and an end wall 1582, and is made of a material that has excellent heat radiation, such as a metal or ceramic. The end wall 1582 is in the shape of a circular plate and closes the upper end of the cylindrical part 1581. Due to the simple shape as such, the heat sink 1580 can be manufactured by the drawing process, and can be made thin. This contributes to reduction in weight of the lamp 1500. Note that the heat sink 1580 may be manufactured by a method, such as diecasting, other than the drawing process.

The cylindrical part 1581 fit to the outside of the circuit housing part 1570, and for example, covers, in its entirety, an outer circumferential surface 1575 of the circuit housing part 1570. The structure covering the whole part increases the surface area of the cylindrical part 1581, improves the heat radiation, and improves the outer appearance of the lamp 1500. The above structure having the heat sink 1580 is in particular effective in a spotlight lamp, which tends to have a problem of increase in temperature due to LED because a small, super-luminosity LED is apt to be used.

The inner diameter of the heat sink 1580 is larger than the outer diameter of the circuit housing part 1570 such that a gap 1501 (see FIG. 24) is formed between an inner circumferential surface 1583 of the heat sink 1580 and an outer circumferential surface 1575 of the circuit housing part 1570, the gap 1501 being approximately uniform all over the inner circumferential surface 1583 in width. The gap makes it difficult for the heat to be transferred from the heat sink 1580 to the circuit housing part 1570, thus making it difficult for the lighting circuit 1550 housed in the circuit housing part 1570 to be destroyed by heat. Also, this structure allows the inner circumferential surface 1583 of the heat sink 1580 and the outer circumferential surface 1575 of the circuit housing part 1570 to be exposed to the air, thus further improving the heat radiation of the heat sink 1580.

The end wall 1582 is provided between the case 1510 and the circuit housing part 1570, closing the opening of the circuit housing part 1570. In the end wall 1582, three screw insertion holes 1584a through 1584c, which are approximately in the same shape as the three screw insertion holes 1515a through 1515c of the case 1510, and two connector insertion holes 1585a and 1585b, which are approximately in the same shape as the connector insertion holes 1516a and 1516b of the case 1510, are formed.

Since, in the lamp 1500, the heat sink 1580 is provided as a separate body from the case 1510 and from the circuit housing part 1570, the heat sink 1580 can be changed in shape and size appropriately based on the level of wattage, while allowing the case 1510 and the circuit housing part 1570 to be used in common in a plurality of types of lamps that have different levels of wattage. This reduces the cost because some structural elements can be used in common, and also facilitates development of various types of lamps.

(Assembly Structure)

The lamp 1500 in Embodiment 4 described above is assembled as follows.

First, the heat sink 1580 is fit to the outside of the circuit housing part 1570 from the front side in the state where the lighting circuit 1550 is housed in the circuit housing part 1570, and then the convexes 1574a through 1574c of the circuit housing part 1570 are passed through the screw insertion holes 1584a through 1584c of the heat sink 1580. Furthermore, the case 1510 is mounted on the end wall 1582 of the heat sink 1580, and the convexes 1574a through 1574c of the circuit housing part 1570 are passed through the screw insertion holes 1515a through 1515c of the case 1510, as well.

Next, the implementation substrate 1521 of the LED module 1520 is mounted on the bottom 1513 of the case 1510, then the connectors 1526 and 1527 are passed through the connector insertion holes 1585a and 1585b and connector insertion holes 1516a and 1516b so that the LED module 1520 and the lighting circuit 1550 are electrically connected with each other, and the LED module 1520 is housed in the case 1510.

Subsequently, the connectors 1526 and 1527 of the LED module 1520 are passed through the connector insertion holes 1516a and 1516b of the case 1510 and the connector insertion holes 1585a and 1585b of the heat sink 1580, and then are caused to engage with the circuit substrate 1551 of the lighting circuit 1550 so that they are electrically connected with each other. The screws 1590a through 1590c are then inserted and screwed in the screw holes 1573a through 1573c. This allows the LED module 1520, case 1510, and heat sink 1580 to be fixed all at once to the circuit housing part 1570 by the screws, facilitating the assembly.

With the above structure of attaching the lid 1530 to the case 1510 by causing the engaging portions 1514 and 1537 of the case 1510 and the lid 1530 to engage with each other, the lamp can be disassembled to the parts only by removing the screws 1590a through 1590c, when it is disassembled for recycling, for example.

Lastly, as shown in FIG. 24, the lid 1530 is attached to the case 1510 by causing the engaging claw 1537 of the lid 1530 to engage with the flange 1514 of the case 1510. Pressing the cover 1531 of the lid 1530 onto the cylindrical portion 1512 of the case 1510 can easily cause the engaging claw 1537 to engage with the flange 1514 of the case 1510.

### Modification of Embodiment 4

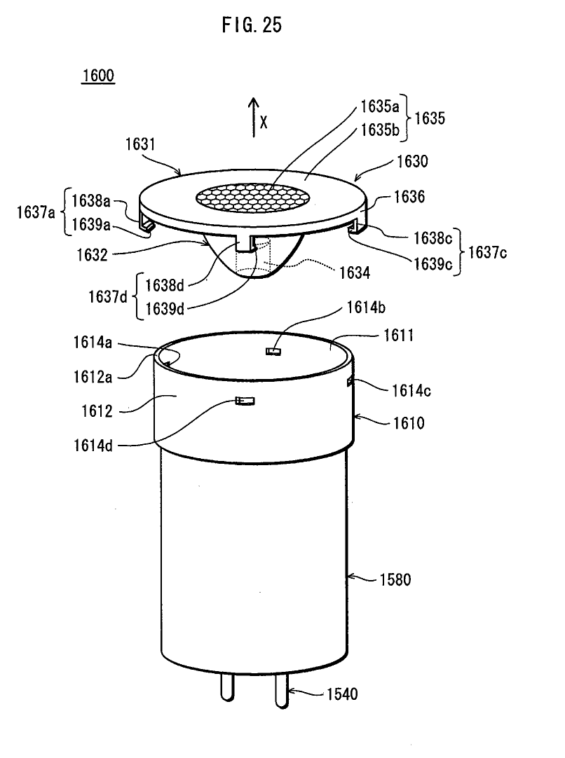

FIG. 25 is an exploded perspective view of the lamp in Modification of Embodiment 4. As shown in FIG. 25, a lamp 1600 of Modification of Embodiment 4 greatly differs from the lamp 1500 of Embodiment 4 in engaging portions 1614a through 1614d of a case 1610 and engaging portions 1637a through 1637d of a lid 1630. In the following, differences are mainly explained, and to avoid redundancy, explanation of similarities to the lamp 1500 in Embodiment 4 is omitted. Note that structural elements that are the same as those of Embodiment 4 are assigned the same reference signs.

The lamp 1600 of Modification of Embodiment 4 includes a case 1610, the LED module 1520 (not illustrated), a lid 1630, the base pins 1540, the lighting circuit 1550 (not illustrated), the circuit housing part 1570 (not illustrated), and the heat sink 1580.

The case 1610 is, for example, made of a material that has excellent heat radiation, such as a metal or ceramic (including glass), and has an opening 1611 on the front side. The case 1610 includes a cylindrical portion 1612 and a bottom (not illustrated) which is in the shape of a circular plate and closes the lower end of the cylindrical portion 1612.

In the vicinity of the front end of the outer circumferential face of the cylindrical portion 1612, four engaging portions 1614a through 1614d are provided at regular intervals along the circumferential direction. Each of the engaging portions 1614a through 1614d is an approximately rectangular through hole.

The lid 1630 includes: a cover 1631 that is in the shape of an approximately circular plate; and a lens 1632 that is in the shape of a truncated cone whose tip has been cut horizontally. Also, engaging portions 1637a through 1637d (the engaging portion 1637b is not illustrated) are provided in an outer circumference 1636 of the cover 1631, at regular intervals along the circumferential direction of the outer circumference 1636. The engaging portions 1637a through 1637d are respectively provided with: tongues 1638a through 1638d that extend from the outer circumference 1636 toward the back side; and engaging claws 1639a through 1639d that project from tips of the tongues 1638a through 1638d toward inside of the case.

The lid 1630 is attached to the case 1610 by causing the engaging portions 1637a through 1637d of the lid 1630 to engage with the engaging portions 1614a through 1614d of the case 1610 (by inserting the engaging claws 1639a through 1639d into the engaging portions 1614a through 1614d). Pressing the cover 1631 onto a front-side end 1612a of the case 1610 can easily cause the engaging claws 1639a through 1639d to engage with the engaging portions 1614a through 1614d.

When, as in the lamp 1500 of Embodiment 4, the flange 1514 was provided in the case 1510, the number of molds used for molding the case 1510 would increase as well. However, a flange is not provided in the case 1610. With this structure, a smaller number of molds are used for molding, and the cost for the structural elements of the case 1610 can be restricted as well. Note that, in the lamp 1100 of Embodiment 3, the adhesive 1190 is used to attach the lid 1130, and a flange is not provided in the case 1110. With this structure, the cost for the structural elements of the case 1110 can be restricted as well.

### Modifications of Embodiments 3 and 4

Up to now, specific examples of the lamp of the present invention have been explained in Embodiments 3 and 4. However, the lamps in Embodiments 3 and 4 are not limited to these examples. For example, the following modifications are considered.

(LED Module)

The LED module is not limited to the module using LEDs, but may be a module using a semiconductor laser diode or an electroluminescence element. Also, the color of the light emitted from the LED module is not limited to white, but any color may be adopted.

(Cover)

The method of attaching the cover to the case is not limited to bonding by the adhesive or engagement by the engaging portions, but may be any other known attachment method such as attachment by the screws.

The optical unit of the cover is not limited to the lens, but may be any other thing such as a Fresnel lens or a reflection mirror as far as it has a function to change the light distribution property of the light emitted from the LED module, by focusing or diffusing the light. When a lens is used as the optical unit, it is preferable that a reflection layer for reflecting the light is provided on the surface of the lens. If the surface of the lens is provided with the reflection layer so that the lens is surrounded by a mirror facing inward, the amount of emitted light increases.

### Embodiment 5

Conventionally, a lamp, as a substitute for a halogen bulb with a reflection mirror, has a structure wherein an LED module is housed inside a case having a similar shape to the reflection mirror, and a lighting circuit for lighting the LEDs is housed inside the base member attached to the case. With this structure, the lamp can be attached to the conventional lighting equipment.

Meanwhile, since the halogen bulbs provide relatively high brightness, the substitutes for the halogen bulbs need to provide high brightness as well. This could be realized by increasing the number of LEDs or increasing the current that is applied to the LEDs. However, any of these measures will enlarge the lighting circuit and prevent the lighting circuit from being housed in the base member having the same size as the base of the halogen bulb.

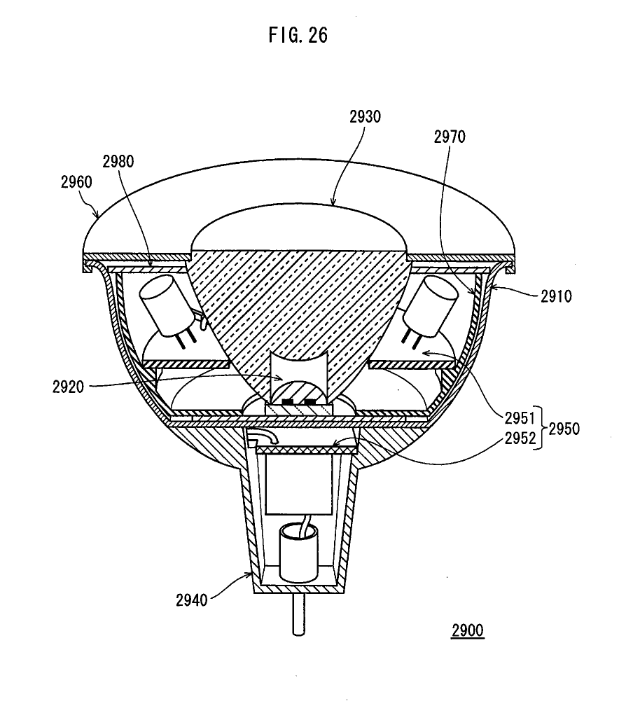

In view of this, as shown in FIG. 26, in a lamp 2900 including a case 2910, an LED module 2920, a lens 2930, a base member 2940, a lighting circuit 2950, and a cover 2960, the lighting circuit 2950 may be divided into a first circuit part 2951 and a second circuit part 2952, and since not both of the first circuit part 2951 and the second circuit part 2952 can be housed in the base member 2940, the first circuit part 2951 is housed in the case 2910.

In the lamp 2900 having the above structure, to prevent the first circuit part 2951 from becoming high in temperature, the case 2910 is preferably made of a metal to increase the heat radiation. Also, when the case 2910 is made of a metal, an insulation case 2970 needs to be provided inside the case 2910 to ensure the electrical insulation between the case 2910 and the first circuit part 2951.

In the above structure, to prevent the first circuit part 2951 from becoming high in temperature with more certainty, the cover 2960 is preferably made of a metal as well. With this structure, the heat, which is to be transferred to the cover 2960 via the case 2910 and lens 2930, is efficiently released to outside, and the heat radiation is further increased.

However, when the cover 2960 is made of a metal, the electrical insulation between the cover 2960 and the first circuit part 2951 needs to be ensured. If, for this purpose, an insulation plate 2980 is provided between the cover 2960 and the first circuit part 2951, the number of structural elements of the lamp 2900 increases. This makes the assembly process complicated and reduces the productivity.

It is therefore an object of Embodiments 5 through 8 to provide a lamp that realizes high brightness without increase in size, and is also high in both heat radiation and productivity.

The lamps of Embodiments 5 through 8 have in common that the cover is made of a metal, and a cover insulation wall is provided as an extension of the lens, the cover insulation wall providing electrical insulation between the cover and the electronic parts housed in the inner space of the case. In this way, since the cover is made of a metal, the heat radiation is increased. Furthermore, since the electrical insulation between the cover and the lighting circuit is ensured by the cover insulation wall that is a part of an optical unit, the insulation plate between the cover and the lighting circuit is not necessary. This reduces the number of structural elements of the lamp and increases the productivity.

The following Embodiments 5 and 8 explain examples of the lamp of the present invention with reference to the attached drawings. Note that in each of the drawings, the direction indicated by arrow X is a lamp lighting direction, and a face of the lamp viewed from the lamp lighting direction is the front face of the lamp.

(Schematic Overview of Lamp Structure in Embodiment 5)

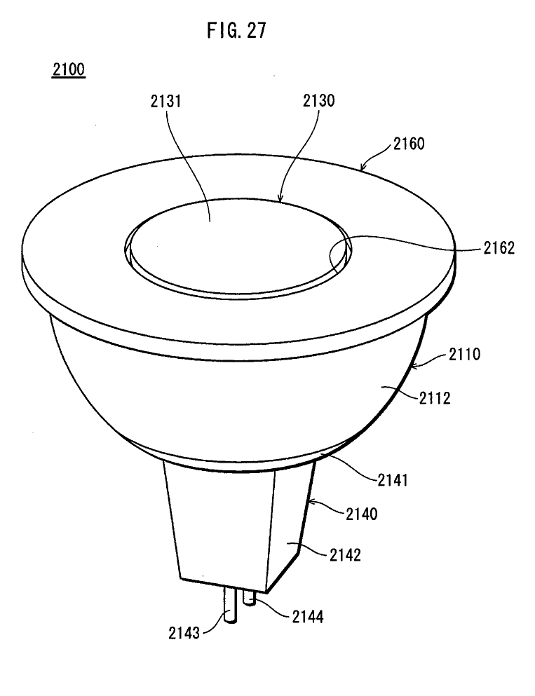

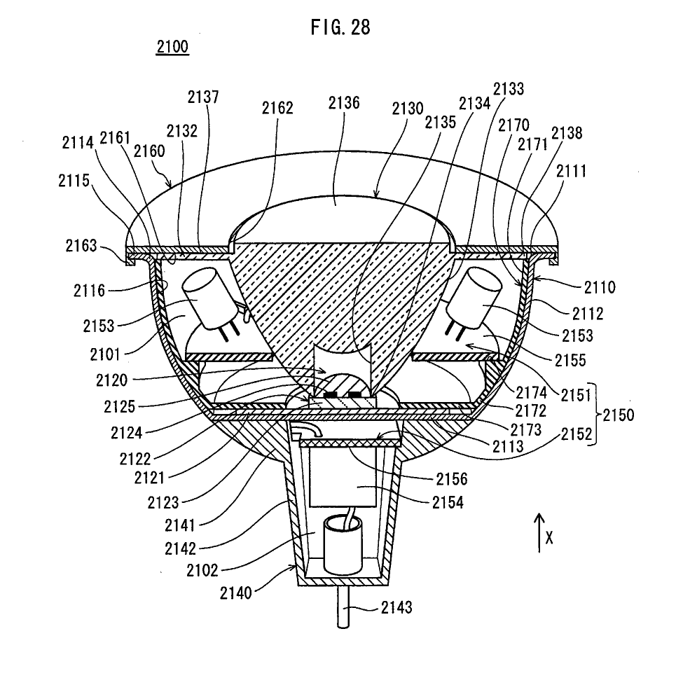

FIG. 27 is a perspective view of the lamp in Embodiment 5. FIG. 28 is a sectional view of the lamp in Embodiment 5. As illustrated in FIG. 27, a lamp 2100 in Embodiment 5 is a substitute for a halogen bulb having an outer appearance conforming to the standard for halogen bulb defined in “JIS C 7527”, and includes, as illustrated in FIG. 28, a case 2110, an LED module 2120, an optical member 2130, a base member 2140, a circuit (lighting circuit) 2150, a cover 2160, and an insulation case 2170.

(Case)

The case 2110, in a conical shape having an opening 2111 on the front side, includes a cylindrical portion 2112 and a bottom 2113 which closes the back side of the cylindrical portion 2112, and houses the LED module 2120, an optical member 2130, and a part of electronic parts constituting the lighting circuit 2150 (the part is a first circuit part 2151 described below), and the insulation case 2170. A ring-like flange 2115 is provided at a front-side end 2114 of the cylindrical portion 2112, and the flange 2115 is used to attach the cover 2160 to the opening 2111.

The case 2110 is made of a metal, and functions as a heat sink that releases the heat, which is generated by the LED module 2120 in the case 2110, to outside. The metal used in the case 2110 is preferably aluminum, taking account of heat radiation, heat resistance, light weight and the like.

(LED Module)

The LED module 2120 is the light source of the lamp 2100, and includes a module substrate 2121 and an LED unit 2122 implemented approximately on the center of the module substrate 2121. The LED module 2120 is mounted approximately on the center of the bottom 2113 inside the case 2110. The LED unit 2122, for example, includes: a unit substrate 2123; LED chips 2124 of the InGaN type with blue emission light implemented on the unit substrate 2123; and a semispherical sealing member 2125 which contains a phosphor for emitting yellow-green light and seals the LED chip 2124 therein. The LED unit 1122 converts a part of blue light emitted from the LED chips 2124 to yellow-green by the phosphor, and emits white light that is generated as a mixture of blue light and yellow-green light.

(Optical Member)

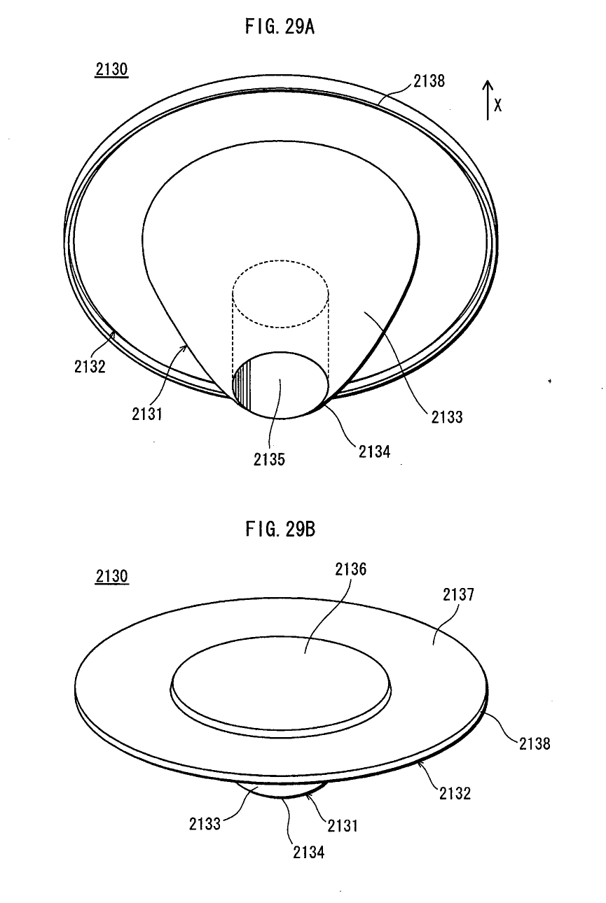

FIGS. 29A and 29B are perspective views of the optical member in Embodiment 5. FIG. 29A is a perspective view looking from the back side. FIG. 29B is a perspective view looking from the front side. As shown in FIGS. 29A and 29B, the optical member 2130, for example, is made of transparent acrylic resin, and includes a lens 2131 and a cover insulation wall 2132 that are formed as one unit. The lens 2131 is in the shape of a truncated cone whose tip has been cut horizontally. The cover insulation wall 2132 is in the shape of a ring-like plate, and provided as an extension from a circumferential surface 2133 of the lens 2131 like a flange.

The material of the optical member 2130 is not limited to the transparent acrylic resin, but is preferably a light transmissive material such as a light transmissive ceramic, glass, or a light transmissive resin other than acrylic, such as polybutylene terephthalate, polycarbonate, or polyethylene.

Also, the structure where the cover insulation wall 2132 is provided as an extension of the lens 2131 is not limited to the structure where the lens 2131 and the cover insulation wall 2132 are formed as one unit. For example, the above structure may be realized by forming two parts separately and connecting them with each other by bonding. Furthermore, the lens 2131 and the cover insulation wall 2132 are not necessarily made of the same material, but may be made of two or more different materials. For example, the lens 2131 may be made of a material having high translucency, and the cover insulation wall 2132 may be made of a material having high thermal conductivity. Also, the optical member 2130 is not necessarily made of a light transmissive material in its entirety, but it is sufficient that at least the lens 2131 is made of a light transmissive material, and the cover insulation wall 2132 may be made of a light-blocking material.

Back to FIG. 28, the lens 2131 is positioned approximately at the center of the case 2110, and on the front side of the LED module 2120. The lens 2131 has a concave 2135 having the shape of an approximate cylinder at a back-side end 2134 thereof, and by fitting a sealing member 2125 of the LED unit 2122 into the concave 2135, the position of the optical member 2130 is determined relative to the LED unit 2122.

The light emitted from the LED module 2120 enters the lens 2131 mainly from the concave 2135, passes through the lens 2131, and is extracted to outside of the case 2110 from a front face 2136 of the lens 2131. The light distribution property of the emitted light changes when the light passes through the lens 2131. More specifically, focused by the lens 2131, the emitted light becomes a spotlight similar to the light emitted from a mirrored halogen bulb. Note that the front face 2136 of the lens 2131 has been processed for preventing the glare.

The cover insulation wall 2132 is at the back side of the cover 2160 to close the opening 2111 of the case 2110, and the front face 2137 of the cover insulation wall 2132 and the back face 2161 of the cover 2160 are in a face-to-face contact. Since the cover insulation wall 2132 and the cover 2160 are in a face-to-face contact, the heat is likely to transfer from the optical member 2130 to the cover 2160. Thus the heat generated in the LED unit 2122 can be released, via the optical member 2130, from the cover 2160 to outside efficiently.

(Base Member)

The base member 2140 is a base for supplying power to the LED module 2120, and includes: a bottom part 2141 attached to a bottom 2113 of the case 2110; a projecting part 2142 projecting flatly from the bottom part 2141 toward the back side; and a pair of base pins 2143 and 2144 attached to the projecting part 2142. The base member 2140 has a shape defined in the JIS C 7709 standard that can be adapted to the socket for halogen bulb. The projecting part 2142 is in the shape of a cylinder which is rectangular in a transverse section, and has inside a second space 2102 for housing a second circuit 2152 of the lighting circuit 2150.

### (Lighting Circuit)

The lighting circuit 2150, for example, may be a lighting circuit provided with: a rectifier circuit that rectifies an AC power supplied from a commercial power source to a DC power; and a voltage adjustment circuit that adjusts a voltage value of the DC power rectified by the rectifier circuit. The lighting circuit 2150 is electrically connected with the base pins 2143 and 2144 and the LED unit 2122, receives power via the base pins 2143 and 2144, and causes LEDs 2124 of the LED unit 2122 to emit light.

The lighting circuit 2150 is composed of a first circuit 2151 and a second circuit 2152. The first circuit 2151 is housed in a first space 2101 between the insulation case 2170 in the case 2110 and the lens 2132. The second circuit 2152 is housed in a second space 2102 inside the projecting part 2142 of the base member 2140. The circuit function of the lighting circuit 2150 can be realized by a plurality of electronic parts 2153 and 2154. The plurality of electronic parts 2153 and 2154 are implemented, in distribution, on a first substrate 2155 of the first circuit 2151 and a second substrate 2156 of the second circuit 2152.

More specifically, the electronic parts 2153 having high heat resistance such as the electrolytic capacitors constituting a smoothing circuit and the switching elements (transistors or the like) constituting an inverter circuit are housed in the first space 2101 close to the LED module 2120 which is the heat source, basically in the state where the electronic parts 2153 are implemented on the first substrate 2155. On the other hand, electronic parts 2154 having low heat resistance such as a coil functioning as a noise filter, and a resistor, are housed in the second space 2102 positioned away from the LED module 2120, basically in the state where the electronic parts 2154 are implemented on the second substrate 2156.

In the lamp 2100, since the electronic parts 2153 and 2154 are housed in distributed places, the lighting circuit 2150 is housed in the lamp without increasing the size of the base member 2140 and the case 2110. Also, among the electronic parts 2153 and 2154 constituting the lighting circuit 2150, there are some parts, such as a resistor and a noise filter, that generate heat. In this structure, the electronic parts having a low heat resistance and the electronic parts that generate heat are stored separately in two distributed spaces.

The first circuit part 2151 is electrically insulated by the cover 2160 and the cover insulation wall 2132 of the optical member 2130. Since the optical member 2130 includes the cover insulation wall 2132, an insulation plate for providing electrical insulation between the first circuit part 2151 and the cover 2160 is not necessary. Accordingly, this structure reduces the number of structural elements of the lamp 2100 and increases the productivity.

(Cover)

The cover 2160 is made of a metal and in the shape of a ring-like plate, has an approximately circular light emission window 2162 at a position corresponding to the lens 2131, and is attached to the opening 2111 of the case 2110 by swaging an outer circumference 2163 to the flange 2115 of the case 2110. Note that the outer circumference 2163 may be swaged to the flange 2115 over the whole circumference or may be swaged at a plurality of positions located at intervals along the circumferential direction.

The cover 2160 urges the optical member 2130 toward the back face. This causes the back face 2161 of the cover 2160 and the front face 2137 of the cover insulation wall 2132 to be in face-to-face contact, causes an outer circumference 2138 of the cover insulation wall 2132 to be in contact with the opening 2171 of the insulation case 2170, and causes a back-side end 2134 of the lens 2131 to be in contact with the LED module 2120.

This restricts the movement of the optical member 2130 in the front and back direction, preventing the positional shift and backlash of the optical member 2130. Also, since the back face 2161 of the cover 2160 and the front face 2137 of the cover insulation wall 2132 is in close contact, the heat is allowed to transfer from the optical member 2130 to the cover 2160. This improves the heat radiation of the lamp 2100. Furthermore, the opening 2171 of the insulation case 2170 is approximately closed by the cover insulation wall 2132. This prevents water or the like from entering the first space 2101.

The front face 2137 of the cover insulation wall 2132 is covered by the cover 2160. This makes the outer appearance of the lamp 2100 excellent in that the first circuit 2151 and the LED module 2120 housed in the case 2110 are difficult to be seen through from outside.

(Insulation Case)

The insulation case 2170, which is in the shape of a cone and is slightly smaller than the case 2110, has the opening 2171 on the front side thereof, and is composed of a cylindrical portion 2172 and a circular-plate-like bottom 2173 which closes the back side of the cylindrical portion 2172. The insulation case 2170 is arranged along an inner surface 2116 of the case 2110. Furthermore, the inner surface of the cylindrical portion 2172 is provided with a mounting face 2174 for the first substrate 2155 of the first circuit 2151 to be mounted thereon. The insulation member 2170 has a function to ensure the insulation between the first circuit 2151 and the case 2110, and is made of an insulation material such as silicon resin or ceramic.

Note that if the case 2110 is made of an insulation material such as resin or ceramic, the insulation case 2170 is not necessarily required.

### Embodiment 6

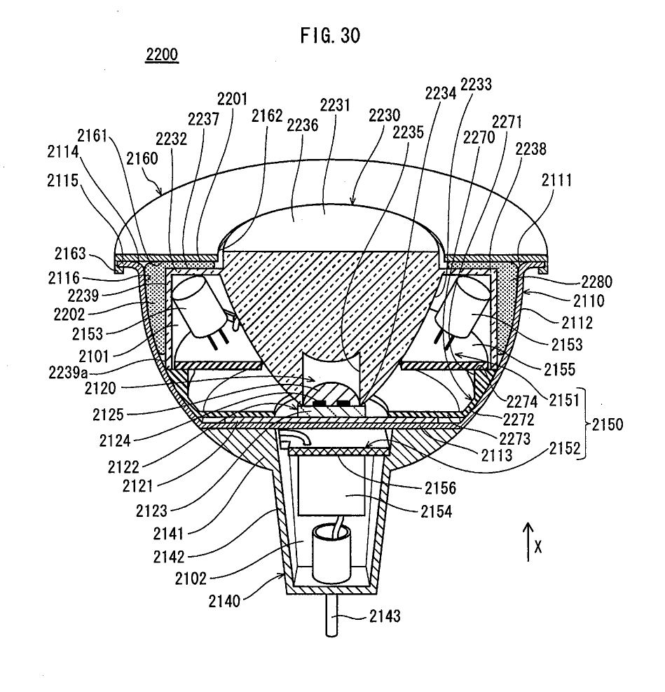

FIG. 30 is a sectional view of the lamp in Embodiment 6. As shown in FIG. 30, a lamp 2200 of Embodiment 6 greatly differs from the lamp 2100 of Embodiment 5 in that a case 2239 is provided in an optical member 2230. In the following, differences are mainly explained, and to avoid redundancy, explanation of similarities to the lamp 2100 in Embodiment 5 is omitted. Note that structural elements that are the same as those of Embodiment 5 are assigned the same reference signs.

As shown in FIG. 30, the optical member 2230 of the lamp 2200 in Embodiment 6, for example, is made of transparent acrylic resin, and includes a lens 2231, a cover insulation wall 2232, and the case insulation wall 2239 that are formed as one unit. The lens 2231 is in the shape of an approximate truncated cone. The cover insulation wall 2232 is in the shape of a ring-like plate, and provided as an extension from a circumferential surface 2233 of the lens 2231 like a flange. The case insulation wall 2239 is in the shape of an approximate cylinder, extending from an outer circumference 2238 of the cover insulation wall 2232 toward the back side.

Note that the lens 2231, cover insulation wall 2232, and case insulation wall 2239 may not necessarily be formed as one unit, but a plurality of parts corresponding thereto may be formed separately and then connected with each other by, for example, bonding. For example, the optical member 2230 may be formed by putting together the lens 2231, cover insulation wall 2232, and case insulation wall 2239 that have been formed as different parts. Furthermore, the lens 2231 and the cover insulation wall 2232 are not necessarily made of the same material, but may be made of two or more different materials. For example, the lens 2231 may be made of a material having high translucency, and the cover insulation wall 2232 and the case insulation wall 2239 may be made of a material having high thermal conductivity. Also, the optical member 2230 is not necessarily made of a light transmissive material in its entirety, but it is sufficient that at least the lens 2231 is made of a light transmissive material, and the cover insulation wall 2232 and the case insulation wall 2239 may be made of a light-blocking material.

The lens 2231 is positioned approximately at the center of the case 2110, and on the front side of the LED module 2120. The lens 2231 has a concave 2235 having the shape of an approximate cylinder at a back-side end 2234 thereof, and by fitting a sealing member 2125 of the LED unit 2122 into the concave 2235, the position of the optical member 2230 is determined relative to the LED unit 2122.

The cover insulation wall 2232 is at the back side of the cover 2160 to close the opening 2111 of the case 2110, and the front face 2237 of the cover insulation wall 2232 and the back face 2161 of the cover 2160 face each other across a gap 2201 therebetween. The case insulation wall 2239 is provided inside the cylindrical portion 2112 of the case 2110, and an outer circumferential surface 2239a of the case insulation wall 2239 and the inner surface 2116 of the case 2110 face each other across a gap 2202 therebetween. The gaps 2201 and 2202 are filled with an adhesive 2280.

The adhesive 2280 bonds the optical member 2230, case 2210, and cover 2260 together, improves the thermal conductivity among the optical member 2230, case 2210, and cover 2260, and improves the heat radiation of the lamp 2200. Note that the adhesive 2280 may be filled in both the gaps 2201 and 2202, or may be filled in either of the gaps 2201 and 2202. Furthermore, the adhesive 2280 may be filled in the gap over the whole circumference of the optical member 2230, or may be applied at a plurality of positions with intervals therebetween.

The insulation case 2270 is in a conical shape, having an opening 2271 on the front side. The insulation case 2270 includes: a cylindrical portion 2272; and a bottom 2273 which closes the back side of the cylindrical portion 2272. Furthermore, the inner surface of the cylindrical portion 2272 is provided with a mounting face 2274 for the first substrate 2155 of the first circuit 2151 to be mounted thereon. On the mounting face 2274, the case insulation wall 2239 of the optical member 2230 is mounted as well.

The insulation case 2270 does not cover the whole inner surface 2116 of the case 2110, and a part (a part on the front side) of the cylindrical portion 2112 is not covered by the insulation case 2270. The electrical insulation between the first circuit part 2151 and the part not covered by the insulation case 2270 is not ensured by the insulation case 2270, but is ensured by the case insulation wall 2239 of the optical member 2230. Conventionally, if a part of the case 2110 is not covered by the insulation case 2270, an insulation member for covering the part is required. However, in the present embodiment, since the case insulation wall 2239 is provided in the optical member 2230, such an insulation member is not required. Accordingly, this structure reduces the number of structural elements of the lamp 2200, and increases the productivity.

### Embodiment 7

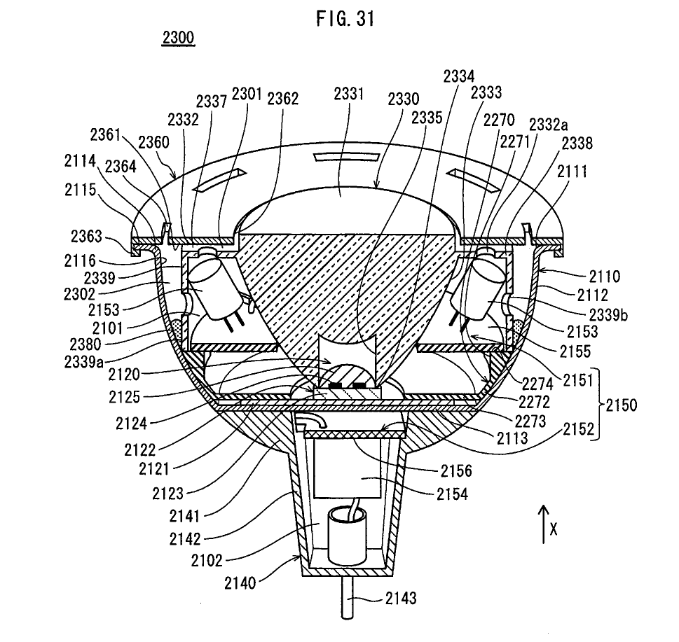

FIG. 31 is a sectional view of the lamp in Embodiment 7. As shown in FIG. 31, a lamp 2300 of Embodiment 7 greatly differs from the lamp 2200 of Embodiment 6 in that through holes 2332a, 2339b and 2364 are provided in an optical member 2330 and a cover 2360. In the following, differences are mainly explained, and to avoid redundancy, explanation of similarities to the lamp 2200 in Embodiment 6 is omitted. Note that structural elements that are the same as those of Embodiment 5 are assigned the same reference signs.

As shown in FIG. 31, the optical member 2330 of the lamp 2300 in Embodiment 7 includes a lens 2331, a cover insulation wall 2332, and a case insulation wall 2339 that are formed as one unit. The lens 2331 is in the shape of an approximate truncated cone and includes a concave 2335 in a back-side end 2334. The cover insulation wall 2332 is in the shape of a ring-like plate, and provided as an extension from a circumferential surface 2333 of the lens 2331 like a flange. The case insulation wall 2339 is in the shape of an approximate cylinder and extends from an outer circumference 2338 of the cover insulation wall 2332 toward the back side.

The cover insulation wall 2332 is at the back side of the cover 2360 to close the opening 2111 of the case 2110, and the front face 2337 of the cover insulation wall 2332 and the back face 2361 of the cover 2360 face each other across a gap 2301 therebetween. The case insulation wall 2339 is provided inside the cylindrical portion 2112 of the case 2110, and the outer circumferential surface 2339a of the case insulation wall 2339 and the inner surface 2116 of the case 2110 face each other across a gap 2302 therebetween.

The cover 2360 is made of a metal and in the shape of a ring-like plate, has an approximately circular light emission window 2362 at a position corresponding to the lens 2331, and is attached to the opening 2111 of the case 2110 by swaging an outer circumference 2363 to the flange 2115 of the case 2110.

A plurality of through holes 2332a are provided in the cover insulation wall 2332 of the optical member 2330; and a plurality of through holes 2339b are provided in the case insulation wall 2339. Furthermore, a plurality of through holes 2364 are provided in the cover 2360. The first space 2101 communicates with outside via the through holes 2332a, 2339b, and 2364, and the gaps 2301 and 2302. Accordingly, since the air comes and goes through the first space 2101, the heat generated in the LED module 2120 is likely to be released to outside, and the lamp 2300 has a high heat radiation.

Adhesive 2380 is filled in the gap 2302 so as not to plug the through holes 2339b, and bonds the optical member 2330 and the case 2110 together. This structure improves the thermal conductivity among the optical member 2330 and the case 2110, and improves the heat radiation of the lamp 2300. Note that the adhesive 2380 may be filled in the gap 2301 so as not to plug the through holes 2332a, or may be filled in both the gaps 2301 and 2302. Furthermore, the adhesive may be filled in the gap over the whole circumference of the optical member 2330, or may be applied at a plurality of positions with intervals therebetween.

### Embodiment 8

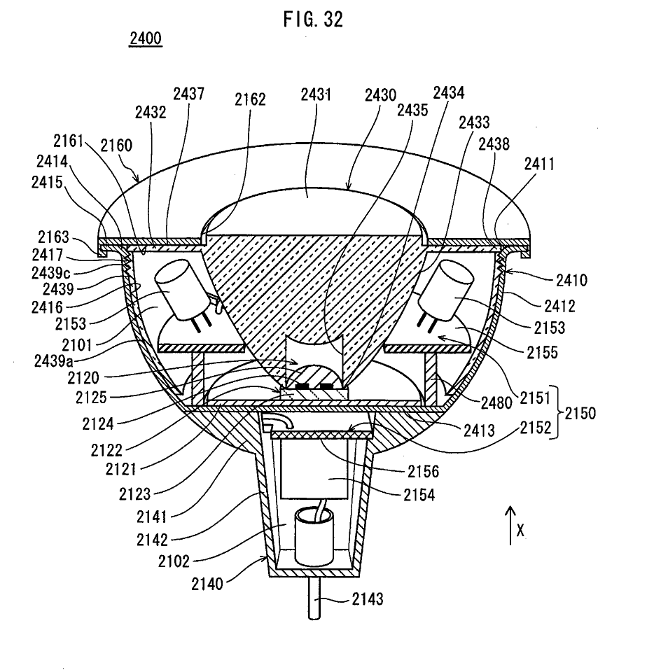

FIG. 32 is a sectional view of the lamp in Embodiment 8. As shown in FIG. 32, a lamp 2400 of Embodiment 8 greatly differs from the lamp 2100 of Embodiment 5 in that the insulation between a cylindrical portion 2412 of a case 2410 and the first circuit part 2151 is ensured only by an optical member 2430. In the following, differences are mainly explained, and to avoid redundancy, explanation of similarities to the lamp 2100 in Embodiment 5 is omitted. Note that structural elements that are the same as those of Embodiment 5 are assigned the same reference signs.

As shown in FIG. 32, the case 2410 of the lamp 2400 in Embodiment 8 includes: a cylindrical portion 2412 that has an opening 2411 on the front side and is in the shape of a cone; and a circular-plate-like bottom 2413 which closes the back side of the cylindrical portion 2412. The case 2410 houses inside the LED module 2120, the optical member 2430, and the first circuit part 2151. The approximate-ring-like flange 2415 is provided at a front-side end 2414 of the cylindrical portion 2412, and the flange 2415 is used to attach the cover 2160 to the opening 2411. The case 2410 is made of a metal, and functions as a heat sink that releases the heat, which is generated by the LED module 2120 in the case 2410, to outside.

The optical member 2430 includes a lens 2431, a cover insulation wall 2432, and a case insulation wall 2439. The lens 2431 is in the shape of an approximate truncated cone and includes a concave 2435 in a back-side end 2434. The cover insulation wall 2432 is in the shape of a ring-like plate, and provided as an extension from a circumferential surface 2433 of the lens 2431 like a flange. The case insulation wall 2439 is in the shape of a cylinder and extends from an outer circumference 2438 of the cover insulation wall 2432 toward the back side, the case insulation wall 2439 being provided along the cylindrical portion 2412 of the case 2410.

The lens 2431 and the cover insulation wall 2432 are formed as one unit. On the other hand, the case insulation wall 2439 is made as a separate part different from the above parts, and is attached to the cover insulation wall 2432 before the lamp 2400 is assembled. In this way, by preparing the case insulation wall 2439 as a separate part, it is possible to obtain the optical member 2330 having a complicated shape that cannot be formed if the case insulation wall 2439 is formed as one unit with other parts.

The case insulation wall 2439 covers approximately the whole inner surface of the cylindrical portion 2412, ensuring the electrical insulation between the first circuit part 2151 and the cylindrical portion 2412. Note that the first circuit part 2151 is supported by a supporting member 2480, which has the shape of an approximate cylinder and is mounted on the bottom 2413, such that the first circuit part 2151 is above the bottom 2413 with a space therebetween. With this structure, the electrical insulation between the first circuit part 2151 and the bottom 2413 is ensured as well. With such a structure, the electrical insulation between the first circuit part 2151 and the case 2410 is ensured even if an insulation case is not provided.

An engaging part 2417 for engaging the case 2410 and the optical member 2430 is provided in the inner surface 2416 of the case 2410 (the inner surface of the cylindrical portion 2412). Also, an engaging part 2439c is provided in an outer circumferential surface 2439a of the case insulation wall 2439 of the optical member 2430, at a position corresponding to the engaging part 2417 of the case 2410. The engaging part 2417 of the case 2410 and the engaging part 2439c of the optical member 2430 are, for example, grooves, and the optical member 2430 and the case 2410 are screwed in the state where the engaging parts 2417 and 2439c mesh with each other, so that the optical member 2430 and the case 2410 are connected with each other, with the outer circumferential surface 2439a of the case insulation wall 2439 and the inner surface 2416 of the case 2410 being in a face-to-face contact.

In this structure, since the optical member 2430 and the case 2410 are connected with each other by screwing them while the grooves thereof mesh with each other, adhesive or the like is not necessary. Also, since the outer circumferential surface 2439a of the case insulation wall 2439 and the inner surface 2416 of the case 2410 are in face-to-face contact, the thermal conductivity between the case 2410 and the optical member 2430 is improved, and the heat radiation of the lamp 2400 is improved.

### Modifications of Embodiments 5 through 8

Up to now, specific examples of the lamp of the present invention have been explained in Embodiments 5 through 8. However, the lamps in Embodiments 5 through 8 are not limited to these examples. For example, the following modifications are considered.

(LED Module)

The LED module is not limited to the module using LEDs, but may be a module using a semiconductor laser diode or an electroluminescence element. Also, the color of the light emitted from the LED module is not limited to white, but any color may be adopted.

(Optical Member)

The optical unit of the optical member is not limited to the lens, but may be any other thing such as a Fresnel lens or a reflection mirror as far as it has a function to change the light distribution property of the light emitted from the LED module by focusing or diffusing the light. When a lens is used as the optical unit, it is preferable that a reflection layer for reflecting the light is provided on the surface of the lens. If the surface of the lens is provided with the reflection layer so that the lens is surrounded by a mirror facing inward, the amount of emitted light increases.

### Embodiment 9

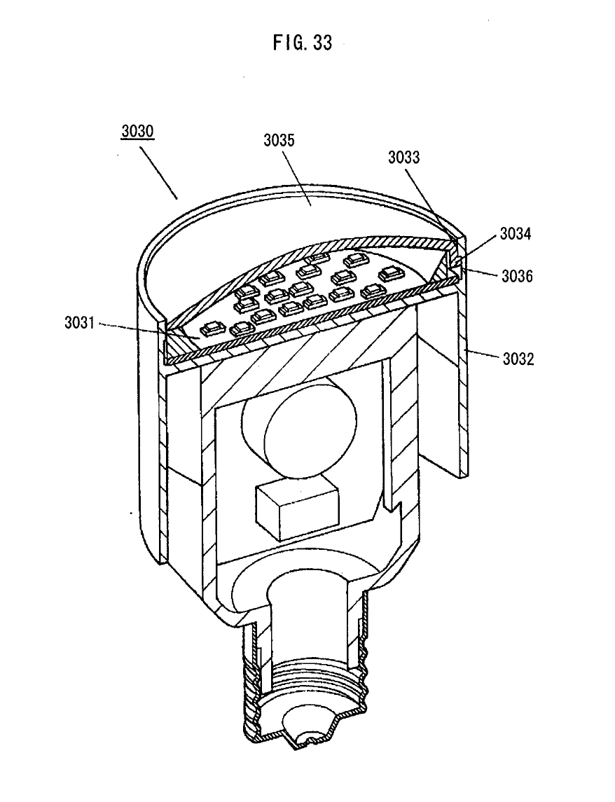

As a conventional technology, Patent Literature 1 discloses a lamp 3030 having a structure shown in FIG. 33, in which an LED module 3031 is housed in a case 3032, and a cover 3035 made of resin is attached to an opening portion 3033 provided in the front face of the case 3032 by causing a plurality of engaging claws 3034 provided in the cover 3035 to engage with claw receiving parts 3036 provided on the inner circumferential surface of the case 3032.

With such a structure, it is possible to attach the cover 3035 to the case 3032 by pressing and fitting the cover 3035 to the opening portion 3033. With this structure, the lamp can be assembled more easily than the method of attaching a metal cover to the case by swaging, or fixing a cover made of a metal or resin to the case by using screws or screwing them while the grooves thereof mesh with each other. When a cover made of a metal or resin is attached to the case by bonding, there is a possibility that the adhesive runs out and a disfigurement is caused. However, with this structure, there is no such possibility. Thus the lamp can be assembled more easily with the present structure than with the structure in which the adhesive is used.

However, with the above structure of the lamp 3030, although it is easy to attach the cover 3035, once the cover 3035 is attached, the engaging claws 3034 of the cover 3035 hide behind the case 3032, and it becomes difficult to remove the cover 3035 when the lamp 3030 is disassembled for recycling, for example.

It is therefore an object of Embodiment 9 to provide a lamp that realizes high brightness without increase in size, and can be assembled and disassembled easily.

In the lamp of Embodiment 9, the cover is attached to the case by causing a plurality of engaging members, which are provided in a face of the cover facing the case, to pass through the through holes provided in the case so that the tips of the passed-through engaging members engage with the case.

With this structure of the lamp of Embodiment 9, the cover can be easily attached to the case by a simple assembly work of causing the engaging members of the cover into the through holes provided in the brim of the case. Also, in the state where the cover is attached to the case, the engaging members are outside of the case. Thus when the lamp is disassembled, the cover can be easily removed from the case by removing the engaging members from the brim of the case. On the other hand, the plurality of engaging claws prevent the cover from being removed by a slight shock. Accordingly, the lamp of the present embodiment is both assembled and disassembled easily, and prevents the cover from being removed by a slight shock.

The following Embodiment 9 explains an example of the lamp of the present invention with reference to the attached drawings.

(Structure Outline)

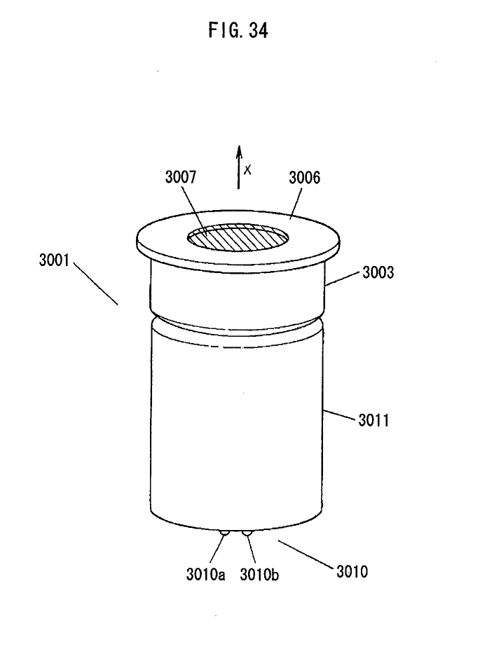

As shown in FIG. 34, a lamp 1 in Embodiment 9 is a spotlight having an outer appearance of an approximate cylinder, and since the lamp 1 is partially common to the halogen bulb defined in “JIS C 7527” in shape, it can be used as a substitute for the halogen bulb.

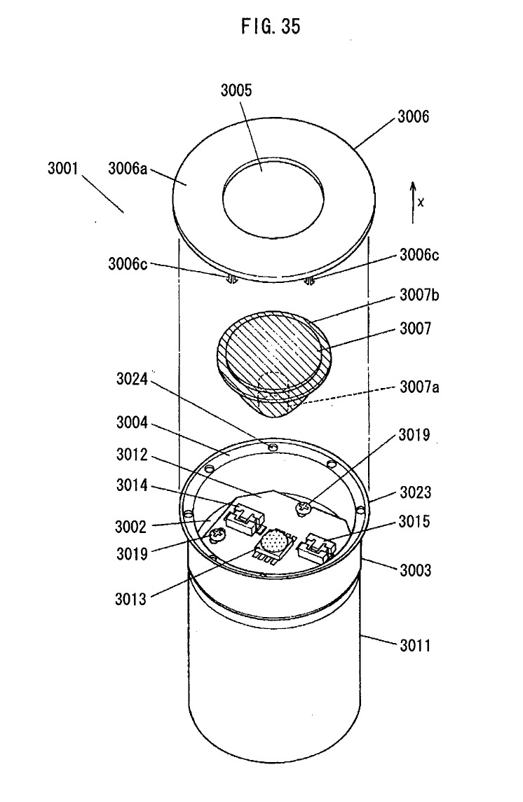

As shown in FIG. 35, a lamp 3001 has a structure in which an LED module 3002 is housed in a case 3003, and a cover 3006 is attached to an opening part 3004 provided on the front side of the case 3003, the cover 3006 having a light emission window 3005 for extracting the light emitted from the LED module 3002 to outside, and a lens 3007, as an optical unit, being fitted in the light emission window 3005. Note that in FIG. 35, the direction indicated by arrow X is the front direction, namely a direction in which the lamp 3001 emits light. This applies to the other drawings as well.

As shown in FIGS. 34 through 36, the lamp 3001 includes an LED module 3002, a case 3003, a cover 3006, and a lens 3007, as well as a circuit (lighting circuit) 3008, a circuit housing part 3009, base pins 3010, and a heat sink 3011.

(LED Module)

The LED module 3002 is the light source of the lamp 3001, and includes an implementation substrate 3012, an LED (light-emitting element) 3013, and a pair of connectors 3014 and 3015.

The implementation substrate 3012 is, for example, a plate in the shape of an approximate octagon which is composed of: a metal plate made of aluminum or the like on which an insulation layer made of thermally conductive resin is formed; a wiring pattern (not illustrated) that is formed on the insulation layer and is to be electrically connected with the LED; and three screw insertion holes 3016, 3017, and 3018 formed at positions not overlapping with the wiring pattern.

As the substrate structure, the substrate may include a ceramic plate on which a wiring pattern is formed to be electrically connected with the LED. Note that the screw insertion holes 3016, 3017, and 3018 are elongated holes that broaden in the same direction in width, so that, when the LED module 3002 is fixed by the screws, the LED module 3002 can be shifted along the elongated holes for adjustment of the position.

The LED 3013, for example, includes: an LED chip of the InGaN type with blue emission light; and a semispherical sealing member which contains a phosphor for emitting yellow light and seals the LED chip therein. The LED 3013 converts a part of blue light emitted from the LED chip to yellow-green by the phosphor, and emits white light that is generated as a mixture of blue light and yellow-green light. The LED 3013 is implemented on the implementation substrate 3012, and is electrically connected with the wiring pattern on the implementation substrate 3012.

Each of connectors 3020a and 3020b is in the shape of an approximate rectangular cylinder, and is provided with a slit to be engaged with the lighting circuit 3008. While the lighting circuit 3008 is inserted in the slit, the connectors 3020a and 3020b fulfill a role of electrical connection.

(Case)

The case 3003 is, for example, a cylindrical member with a bottom and includes a cylindrical portion 3021 and a bottom 3022 which is in the shape of a circular plate and closes the lower end of the cylindrical portion 3021. The case 3003 is made of a material that has excellent heat radiation, such as a metal or ceramic (including glass).

The front end of the cylindrical portion 3021 constitutes an opening portion 3004 of the case 3003. A brim 3023 is provided in the opening portion 3004, the brim 3023 extending outward from an outer circumferential edge of the opening portion 3004, and the cover 3006 is attached by using the brim 3023. The brim 3023 is provided with a plurality of (in the present embodiment, eight) through holes 3024 at predetermined intervals. The through holes 3024 are formed to pass through the case 3003 from the front face to the back face in the brim 3023 extending outward from an outer circumference of the opening portion 3004 of the case 3003. Note that the assembly structure of the cover 3006 will be described later. In the bottom 3022, three approximately circular screw insertion holes 3025 and two approximately rectangular connector insertion holes 3026 are formed. In the present invention, the through holes include: through holes having a shape of the through holes 3024 that are formed to pass through the brim 3023 from the front face to the back face as shown in FIG. 35, and be surrounded by the brim 3023; and through holes that are, for example, formed to pass through the brim 3023 from the front face to the back face, and be in the shape of a notch where a part of the outer circumference of the brim 3023 is cut away.

Note that, when the case 1510 is made of an electrically conductive material, it is preferable that an insulation case or the like is provided inside the case 1510 to ensure the insulation between the case 1510 and electronic parts arranged in the inner space of the case 1510.

(Cover)

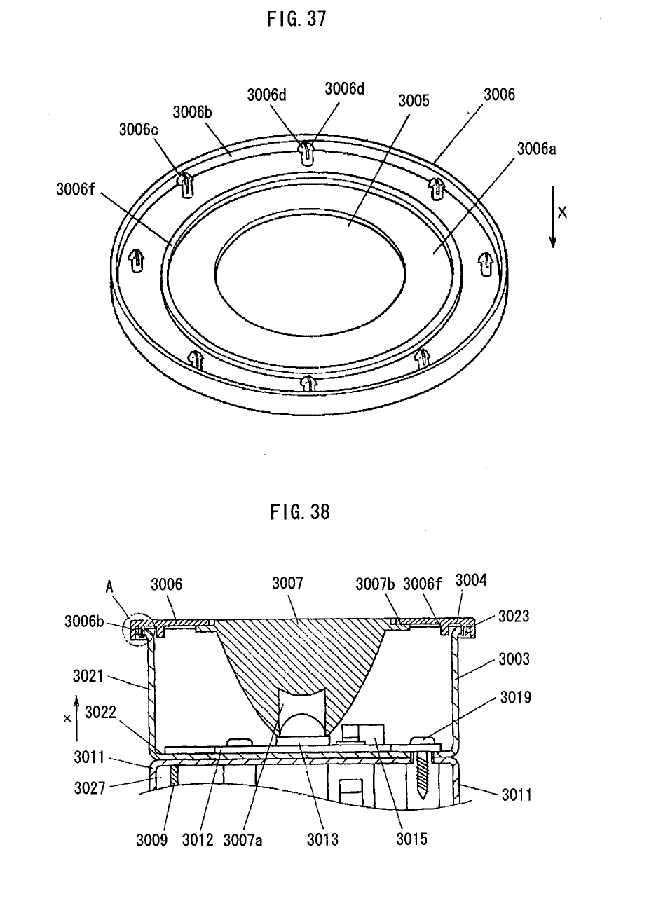

The cover 3006 illustrated in FIGS. 37, 38 and 39 is made of a non-light-transmissive material such as white PBT (polybutylene terephthalate), and includes: a main body 3006a that is in the shape of a ring-like plate and has an approximately circular light emission window 3005; a circumferential wall 3006b that is in the shape of a short cylinder extending backward from the outer circumferential edge of the main body 3006a; and engaging members 3006c that are in the shape of a bar and provided on more inner circumference side than the circumferential wall 3006b, extending backward. The engaging members 3006c are described in detail below. As many as the through holes 3024, namely, eight bar-like engaging members 3006c are provided to stand at the same intervals as the through holes 3024. Note that the bar-like engaging members 3006c may be equal to or less than the through holes 3024 in number. When the bar-like engaging members 3006c are less than the through holes 3024 in number, the cover can be attached to the case 3003. Of course, when the bar-like engaging members 3006c are more than the through holes 3024 in number, the cover cannot be attached to the case 3003. Note that it is preferable that at least three engaging members are provided in the cover at regular intervals, and the through holes 3024 are provided at the corresponding positions in the brim 3023. Each of the bar-like engaging members 3006c is divided into two parts at the tip by a slit 3006g, and each of the two parts has an engaging piece 3006d that projects in the direction perpendicular to the axis.

The resin that constitutes the cover 3006 is not limited to PBT, but may be acrylic, PC (polycarbonate) or the like. PBT is preferred as a material of the cover 3006 since it has high heat resistance, moderate elasticity, and high weather resistance. The cover 3006 is not limited to white. The cover 3006 made of resin can be colored at a low cost.

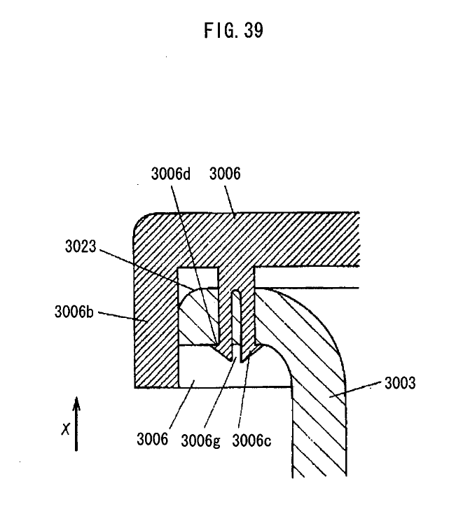

The engaging members 3006c of the cover 3006 are inserted into the through holes 3024 of the case 3003 from their tips. The engaging members 3006c then go through the through holes 3024, with the tips shrinking by the presence of the slits 3006g, in a direction in which the outer diameter thereof becomes smaller, and then after the engaging pieces 3006d go out of the through holes 3024, the tips open in a direction in which the outer diameter thereof becomes larger, the engaging pieces 3006d engage with the back face of the brim 3023 of the case 3003, and the cover is fixed to the case as illustrated in FIGS. 38 and 39. Note that the tips of the engaging members 3006c may be rounded so that they can be inserted into the through holes 3024 more easily. Alternatively, the tips of the engaging members 3006c may be in the shape of a flat plate tapering off to a point, or in the shape of a circular cone or the like. With such a structure, by pinching the tip of the engaging member 3006c between thumb and the first finger, the slit shrinks and the engaging member 3006c becomes easy to be removed from the through hole 3024. Also, since the tip tapers off to a point, it can be inserted into the through hole 3024 easily.

Since, in the cover 3006, a plurality of engaging members 3006c are arranged at intervals, each of the engaging members 3006c independently engages with the brim 3023 of the case 3003 at a corresponding through hole 3024. With such a structure, even if one of the engaging members 3006c is removed from a through hole 3024 of the brim 3023, it does not have an effect to such an extent that any of the other engaging members 3006c is removed as well, and thus the structure prevents the cover 3006 from being removed from the case 3003 by a slight shock. Furthermore, the structure enables the stress, which is applied to the engaging members 3006c when the cover 3006 is attached or detached, to be distributed over the whole cover 3006. Thus with this structure, attachment/detachment can be performed smoothly, and not only the cover 3006, but the engaging members 3006c are difficult to break.

The number of the engaging members 3006c is not limited to eight, but may be determined appropriately based on the lamp size or the like so that the cover 3006 can be attached easily and detached with difficulty, and detached relatively easily when the lamp 3001 is disassembled or when the parts are exchanged.

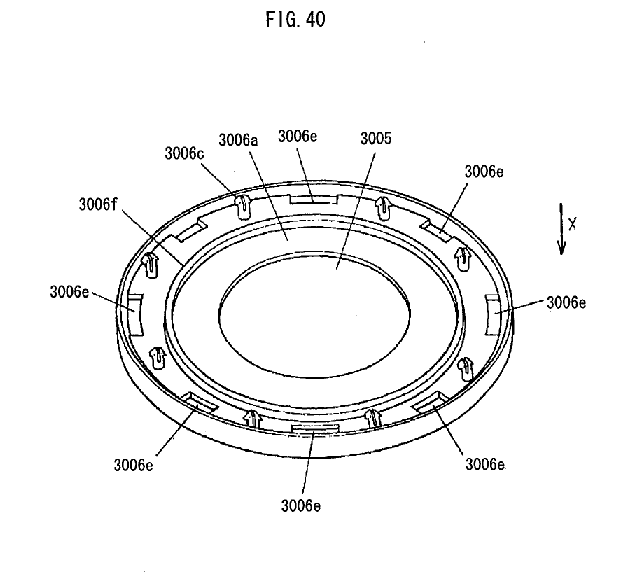

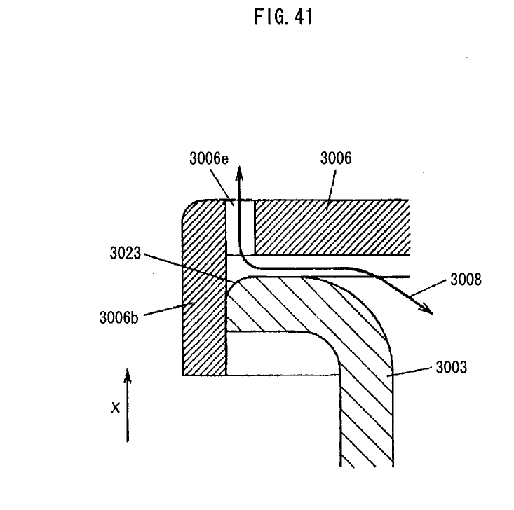

As shown in FIG. 40, holes 3006e may be provided between the engaging members 3006c in the main body 3006a. With this structure, as indicated by an arrow B in FIG. 41, in the state where the cover 3006 is attached to the case 3003, the inside of the case 3003 (the inner space defined by the case 3003 and the cover 3006) communicating with the outside via the holes 3006e. Therefore, since the air flows between the inside of the case 3003 and the outside, it is difficult for the heat generated by the LED module 3002 to stay in the case 3003.

Also, on the back face of the main body 3006a, a rib 3006f in the shape of an approximate ring is provided. This reinforces the strength of the cover 3006.

(Lens)

The lens 3007, for example, is made of transparent acrylic resin, has the shape of an approximate truncated cone, and, as shown in FIG. 38, includes a concave 3007a at the center of its back, the concave 3007a having the shape of an approximate cylinder, and an opening of the concave 3007a being approximately the same as the LED 3013 in diameter. The concave 3007a is attached to cover the LED 3013. This restricts the movement of the lens 3007 in the front and back direction and in the direction perpendicular to the front and back direction. The material of the lens 3007 is not limited to the transparent acrylic resin, but may be a light transmissive material such as other light transmissive resin or glass.

The lens 3007 is an optical member for collecting the light from the LED module 3002. The light emitted from the LED 3013 is acquired by the lens 3007, collected by the lens 3007, and released to outside of the case 3003. When the lamp is used as a spotlight, an LED whose beam angle is at most 140° may be used as the LED 3013 to facilitate the collection of light.

(Lighting Circuit)

The lighting circuit 3008, for example, may be a lighting circuit provided with: a rectifier circuit that rectifies an AC power supplied from a commercial power source to a DC power; and a voltage adjustment circuit that adjusts a voltage value of the DC power rectified by the rectifier circuit. The lighting circuit 3008 causes the LED module 3002 to emit light, by using the commercial power source.

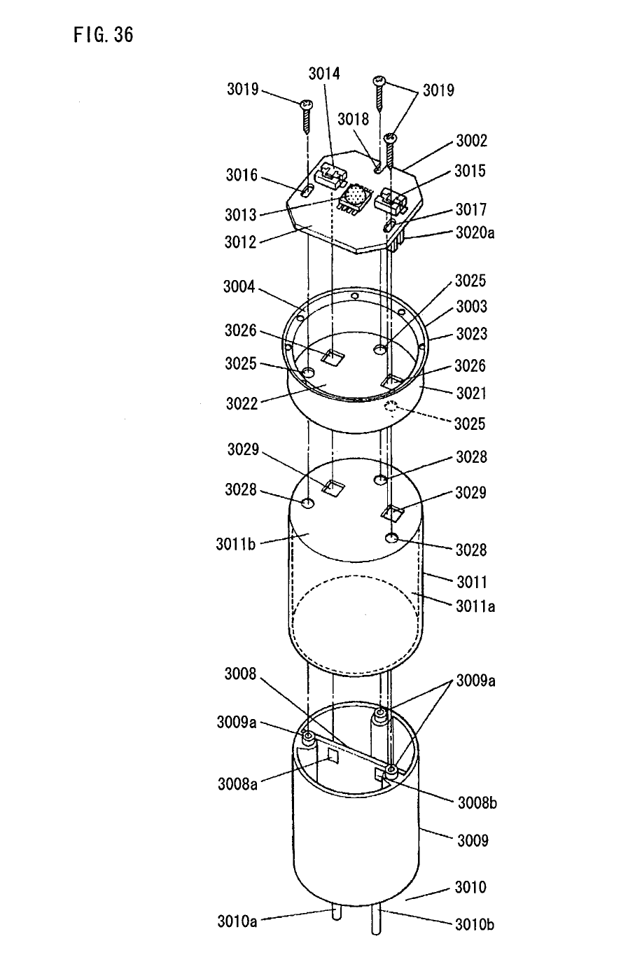

As shown in FIG. 36, the lighting circuit 3008 includes a circuit substrate which is a rectangular plate and on which a plurality of electronic parts (not illustrated) such as a diode, electrolytic capacitor, coil, and resistor are implemented. The electronic parts constituting the lighting circuit 3008 are arranged in the inner space of the case 3003 and the inner space of the circuit housing part 3009. On the circuit substrate of the lighting circuit 3008, terminals 3008a and 3008b, which are electrically connected with the connectors 3020a and 3020b of the LED module 3002, are provided.

(Base Member)

The base member includes a circuit housing part 3009 and base pins 3010.

The circuit housing part 3009, for example, is in the shape of a cylinder with a bottom, wherein the lower end is closed and the upper end is opened, and is made of an insulation material such as resin or ceramic. The circuit housing part 3009 houses the lighting circuit 3008 inside. The circuit housing part 3009 is also provided with three screw holes 3009a on an inner circumferential surface thereof on the front side.

The base pins 3010 are composed of base pins conforming to “GU5.3” defined in the JIS C 7709 standard so as to be adaptable to the socket for halogen bulb. The base pins 3010 illustrated in FIG. 34 are composed of a pair of base pins 3010a and 3010b. The base pins 3010a and 3010b are installed to protrude from the bottom of the circuit housing part 3009, and are electrically connected with the lighting circuit 3008. Note that the base members in Embodiment 9 are not limited to pin bases of “GU5.3”, but may be pin bases of “GU10” or E bases of “E26” or the like.

(Heat Sink)

The heat sink 3011 includes a cylindrical part 3011a and an end wall 3011b, and is made of a material that has excellent heat radiation, such as a metal or ceramic. The end wall 3011b is in the shape of a circular plate and closes the upper end of the cylindrical part 3011a. Due to the simple shape as such, the heat sink 3011 can be manufactured by the drawing process, and can be made thin. This contributes to reduction in weight of the lamp 3001. Note that the heat sink 3011 may be manufactured by a method, such as diecasting, other than the drawing process.

The cylindrical part 3011a fits to the outside of the circuit housing part 3009, and for example, covers, in its entirety, an outer circumferential surface of the circuit housing part 3009. The structure covering the whole part increases the surface area of the cylindrical part 3011a, improves the heat radiation, and improves the outer appearance of the lamp 3001. The above structure having the heat sink 3011 is in particular effective in a spotlight lamp, which tends to have a problem of increase in temperature due to LED because a small, super-luminosity LED is apt to be used.

The inner diameter of the heat sink 3011 is larger than the outer diameter of the circuit housing part 3009 such that a gap 3027 (see FIG. 38) is formed between an inner circumferential surface of the heat sink 3011 and an outer circumferential surface of the circuit housing part 3009, the gap 3027 being approximately uniform in width. The gap 3027 makes it difficult for the heat to be transferred from the heat sink 3011 to the circuit housing part 3009, thus making it difficult for the lighting circuit 3008 housed in the circuit housing part 3009 to be destroyed by heat. Also, this structure allows the inner circumferential surface of the heat sink 3011 and the outer circumferential surface of the circuit housing part 3009 to be exposed to the air, thus further improving the heat radiation of the heat sink 3011.

The end wall 3011b is provided between the case 3003 and the circuit housing part 3009, closing the opening of the circuit housing part 3009. In the end wall 3011b, three screw insertion holes 3028, which are approximately in the same shape as the screw insertion holes 3025 of the case 3003, and two connector insertion holes 3029, which are approximately in the same shape as the connector insertion holes 3026 of the case 3003, are formed.

Since, in the lamp 3001, the heat sink 3011 is provided as a separate body from the case 3003 and from the circuit housing part 3009, the heat sink 3011 can be changed in shape and size appropriately based on the level of wattage, while allowing the case 3003 and the circuit housing part 3009 to be used in common in a plurality of types of lamps that have different levels of wattage. This reduces the cost because some structural elements can be used in common, and also facilitates development of various types of lamps.

(Assembly Structure)

The lamp 3001 in Embodiment 9 described above is assembled as follows.

First, as shown in FIG. 36, the heat sink 3011 is fit to the outside of the circuit housing part 3009 from the front side in the state where the lighting circuit 3008 is housed in the circuit housing part 3009 so that the screw holes 3009a of the circuit housing part 3009 are aligned with the screw insertion holes 3028 of the heat sink 3011. Furthermore, the case 3003 is mounted on the end wall 3011b of the heat sink 3011 so that the screw holes 3009a of the circuit housing part 3009, the screw insertion holes 3028 of the heat sink 3011, and the screw insertion holes 3025 of the case 3003 are aligned with each other. In so doing, the positioning is made relative to the terminals 3008a and 3008b of the lighting circuit 3008 in the state where the connector insertion holes 3029 of the heat sink 3011 and the connector insertion holes 3026 of the case 3003 communicate with each other.

Next, the LED module 3002 is mounted on the bottom of the case 3003, then the connectors 3014 and 3015 are passed through the connector insertion holes 3026 and connector insertion holes 3029 so that the LED module 3002 and the lighting circuit 3008 are electrically connected with each other, and the LED module 3002 is housed in the case 3003.

Next, as shown in FIG. 38, the lens 3007 is mounted on the LED module 3002. Subsequently, the engaging members 3006c of the cover 3006 are inserted into the through holes 3024 of the brim 3023 of the case 3003 so that the engaging members 3006c engage with the case.

An outer circumferential part 3007b is provided to extend from an outer circumferential edge of the lens 3007 in a direction perpendicular to the axis of the lens. The outer circumferential part 3007b is provided at a position located on more back side than the front surface of the lens 3007 by the thickness of the cover 3006. For this reason, there is a step-like difference between the front surface of the lens 3007 and the front surface of the outer circumferential part 3007b. The outer diameter of the outer circumferential part 3007b is larger than the diameter of the light emission window 3005. Accordingly, when the cover 3006 is attached to the case 3003, the lens 3007 is housed inside the light emission window 3005, and the outer circumferential part 3007b of the lens 3007 is covered by the main body 3006a of the cover 3006. This structure prevents the lens 3007 from dropping off from the light emission window 3005. Also, in this state, the lens 3007 is sandwiched by the cover 3006 and the LED module 3002. This restricts the movement of the lens 3007 in the front and back direction, and maintains the state where the LED 3013 is fit in the concave 3007a. This prevents the lens 3007 from being shifted relative to the LED 3013 in position.

The engaging members 3006c of the cover 3006 are not limited to the shape described in the present embodiment, but may be in any shape as far as it allows the engaging members 3006c to pass through the through holes 3024 of the brim 3023 of the case 3003 and engage with the case. For example, the engaging members 3006c may be formed in the shape of a bar, and after they are passed through the through holes 3024 of the brim 3023, the tips of the engaging members 3006c may be deformed to be larger than the through holes 3024 in diameter so that the cover 3006 engages with the case 3003.

Also, the case may be made of a light transmissive material. In that case, the light emitted from the LED module passes through the case and leaks from the side of the lamp to outside. This broadens the lighting region of the lamp. Note that the light transmissive material may be light transmissive ceramic such as glass. The above structure is especially effective in the case where the lamp is not used as a spotlight lamp. In this case, it is further preferable that the case is made of a material that has the light diffusion function. Furthermore, it is further preferable that the case is paired with a cover having translucency and light diffusion function.

(Cover)

The material of the cover is not limited to a non-light-transmissive resin, but may be a light transmissive resin. The cover made of a light transmissive resin enables the light to be emitted from the whole front face of the lamp. Also, the light that leaks from the lens reflection surface is extracted from the cover to outside of the case, thus the amount of emitted light increases. Furthermore, the cover may be made of a resin having translucency and light diffusion function. With this structure, the light emitted from the LED module is diffused at the cover, providing a light distribution pattern that is closer to that of the incandescent lamp. Furthermore, the light emission window of the cover may not be opened, but may be closed by a light transmissive resin or the like.

(Lens)

The optical member may be a Fresnel lens or a reflection mirror. When a lens is used as the optical member, it is preferable that a reflection layer for reflecting the light is provided on the surface of the lens. If the surface of the lens is provided with the reflection layer so that the lens is surrounded by a mirror facing inward, the amount of emitted light increases. Note that the lamp may not include the optical member.

### [Summary of Lamp]

The lamp of the present invention may be any combination of structural elements of Embodiments 1 through 9 and Modifications thereof.

### [Lighting Apparatus]

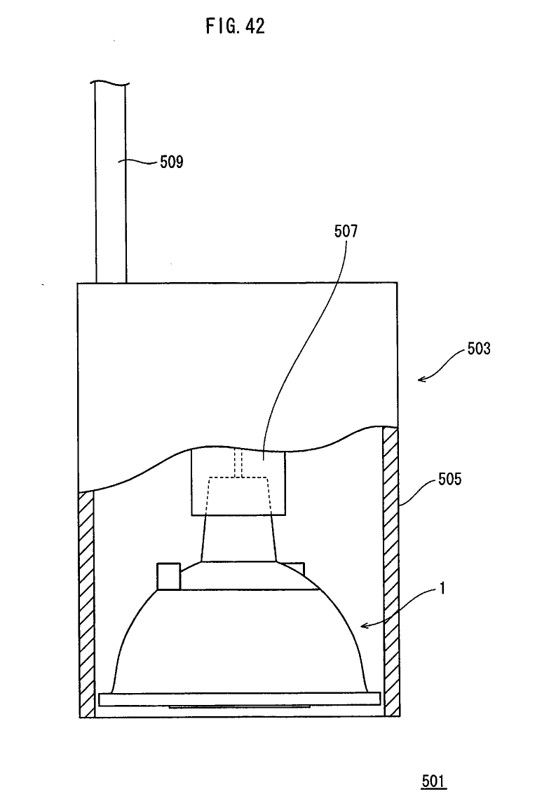

FIG. 42 is a partially cutaway view illustrating the outline structure of the lighting apparatus in an embodiment of the present invention.

A lighting apparatus 501, for example, is used as spotlight lighting in a house, shop, studio or the like. The lighting apparatus 501 includes lighting equipment 503 and a lamp 505.

The lighting equipment 503 includes: an equipment body 505 having the shape of a cylinder with a bottom; a socket 507 being electrically connected with and holding the lamp 1; and a connection unit 509 connected with a commercial power source which is outside the drawing area.

### INDUSTRIAL APPLICABILITY

The lamp of the present invention can be used to realize high brightness without increase in size.

### REFERENCE SIGNS LIST

1 lamp

3 case

7 LED module

13 lens

15 cover

17 lens

23 lighting circuit

25 first circuit part

27 second circuit part

53 first substrate

87 second substrate

1. A lamp comprising:
a light source including one or more light-emitting elements;
a case in a shape of a cylinder having a bottom on whose inner surface the light source is arranged;
a lens being smaller than the case in size and positioned in the case in a state where a light emission face of the lens is on an opening side of the case;
a cover covering at least a space between the lens and the case;
a base member being hollow inside and attached to an outer surface of the bottom of the case to project outside the case; and
a circuit receiving electricity via the base member and causing the light source to emit light,
electronic parts, which constitute the circuit, being arranged in inner spaces of the case and the base member in distribution.

2. The lamp of claim 1, wherein
the lens is in a shape of a truncated cone, a large diameter side thereof being on the opening side of the case, and a small diameter side thereof being on a light source side of the case.

3. The lamp of claim 1, wherein
one or more electronic parts arranged in the base member generate a larger amount of heat than one or more electronic parts arranged in the case.

4. The lamp of claim 1, wherein
the cover and the lens have been formed as one unit to be a lid that closes an opening of the case.

5. The lamp of claim 4, wherein
the lid has been bonded to the case by an adhesive.

6. The lamp of claim 4, wherein
in a face of the lid facing the case, a fitting portion that fits to a front-side end of the case is provided.

7. The lamp of claim 4, wherein
the lid and the case have respective engaging portions, and the lid has been attached to the case by causing the engaging portions of the lid and the case to engage with each other.

8. The lamp of claim 4, wherein
a front surface of the cover has been processed in its entirety to have a light diffusion function.

9. The lamp of claim 4, wherein
the lid includes a plurality of lenses.

10. The lamp of claim 1, wherein
the cover is made of a metal, and the lens includes a cover insulation wall as an extension thereof, the cover insulation wall electrically insulating, from the cover, one or more electronic parts arranged in an inner space of the case.

11. The lamp of claim 10, wherein
the case is made of a metal, and a case insulation wall has been extended from the cover insulation wall, the case insulation wall electrically insulating, from the case, the one or more electronic parts arranged in the inner space of the case.

12. The lamp of claim 10, wherein
the cover insulation wall and the cover are in a face-to-face contact.

13. The lamp of claim 11, wherein
the case insulation wall and the case are in a face-to-face contact.

14. The lamp of claim 10, wherein
a gap has been provided between the cover and the cover insulation wall.

15. The lamp of claim 14, wherein
the gap between the cover and the cover insulation wall has been filled with an adhesive.

16. The lamp of claim 11, wherein
a gap has been provided between the case and the case insulation wall.

17. The lamp of claim 16, wherein
the gap between the case and the case insulation wall has been filled with an adhesive.

18. The lamp of claim 10, wherein
each of the cover and the cover insulation wall has through holes, and the inner space of the case communicates with outside of the case via the through holes.

19. The lamp of claim 11, wherein
each of the cover and the case insulation wall has through holes, and the inner space of the case communicates with outside of the case via the through holes.

20. The lamp of claim 10, wherein
the cover insulation wall and the case are connected with each other by being screwed while grooves of the cover insulation wall and the case mesh with each other.

21. The lamp of claim 11, wherein
the case insulation wall and the case are connected with each other by being screwed while grooves of the case insulation wall and the case mesh with each other.

22. The lamp of claim 1, wherein
the cover has been attached to the case by causing a plurality of engaging members, which are provided in a face of the cover facing the case, to pass through through holes provided in the case, and causing tips of passed-through engaging members to engage with the case.

23. The lamp of claim 22, wherein
the through holes are provided in a brim of the case, the brim extending from an opening part of the case toward outside of the case.

24. The lamp of claim 22, wherein
the plurality of engaging members are provided in a face of the cover facing the case, along an outer circumference of the cover at intervals.

25. A lighting apparatus comprising a lamp and lighting equipment to which the lamp has been attached in a detachable state,
the lamp being the lamp defined in claim 1.
